(19) United States
(12) Patent Application Publication
(10) Pub. No.: US 2025/0344172 A1
(43) Pub. Date: Nov. 6, 2025

(54) TIME SYNCHRONIZATION COMMUNICATION SYSTEM, RELAY NODE, AND STORAGE MEDIUM STORING MESSAGE TRANSFER CONTROL PROGRAM

(71) Applicant: DENSO CORPORATION, Kariya-city (JP)

(72) Inventor: Shinya OKUBO, Kariya-city (JP)

(21) Appl. No.: 19/264,513

(22) Filed: Jul. 9, 2025

Related U.S. Application Data
(63) Continuation of application No. PCT/JP2024/000269, filed on Jan. 10, 2024.

(30) Foreign Application Priority Data
Jan. 30, 2023 (JP) 2023-012072

(51) Int. Cl. H04W 56/00; H04L 47/62

(52) U.S. Cl. CPC H04W 56/0015; H04L 47/6225; H04W 56/0065

(57) ABSTRACT

A time synchronization communication system includes a plurality of nodes transmit and receive a time synchronization message via a communication network. The plurality of nodes include a first time synchronization end station, a second time synchronization end station, and a relay node that relays the time synchronization message. The relay node includes a plurality of ports that communicate with the first time synchronization end station and the second time synchronization end station, each of the plurality of ports has a plurality of transmission queues.

### CROSS REFERENCE TO RELATED APPLICATION

The present application is a continuation application of International Patent Application No. PCT/JP2024/000269 filed on Jan. 10, 2024 which designated the U.S. and claims the benefit of priority from Japanese Patent Application No. 2023-012072 filed on Jan. 30, 2023. The entire disclosures of all of the above applications are incorporated herein by reference.

### TECHNICAL FIELD

The present disclosure relates to a time synchronization communication system, a relay node, and a message transfer control program.

### BACKGROUND

A related art discloses a configuration in which a time synchronization non-compatible Ethernet switch that does not correspond to the timestamp of the time synchronization standard is arranged as a time synchronization bridge between the time synchronization master and the time synchronization slave.

### SUMMARY

According to an aspect of the present disclosure, a time synchronization communication system includes a plurality of nodes transmit and receive a time synchronization message via a communication network. The plurality of nodes include: a first time synchronization end station; a second time synchronization end station; and a relay node that relays the time synchronization message transmitted and received between the first time synchronization end station and the second time synchronization end station. The relay node includes a plurality of ports that communicate with the first time synchronization end station and the second time synchronization end station. Each of the plurality of ports has a plurality of transmission queues capable of storing messages to be transmitted and set with a predetermined transmission priority control method. The plurality of transmission queues include one first transmission queue storing the time synchronization message and one or more second transmission queues storing messages other than the time synchronization message. A transmission priority of the first transmission queue is set higher than a transmission priority of the second transmission queue. The first time synchronization end station, the second time synchronization end station, and the relay node are arranged in a same electronic control unit.

### BRIEF DESCRIPTION OF DRAWINGS

Objects, features and advantages of the present disclosure will become more apparent from the following detailed description made with reference to the accompanying drawings. In the drawings:

FIG. 1 is a functional block diagram showing the overall configuration of the first embodiment;

FIG. 2 is a functional block diagram showing the configuration of the second ECU and the third ECU;

FIG. 3 is a diagram showing the configuration of the time synchronization bridge;

FIG. 4 is a diagram showing the transmission priority;

FIG. 5 is a diagram showing the transmission queue setting of the comparative example;

FIG. 6 is a diagram showing the transfer setting of the comparative example;

FIG. 7 is a diagram explaining the measurement of propagation delay time;

FIG. 8 is a diagram explaining the residence time of the propagation delay measurement request message in the time synchronization bridge of the comparative example;

FIG. 9 is a diagram explaining the residence time of the first propagation delay measurement response message in the time synchronization bridge of the comparative example;

FIG. 10 is a diagram explaining the distribution of the reference time;

FIG. 11 is a diagram explaining the residence time of the first synchronization message in the time synchronization bridge of the comparative example;

FIG. 12 is a diagram explaining the case where the time synchronization error is minimized;

FIG. 13 is a diagram explaining the case where the time synchronization error is minimized;

FIG. 14 is a diagram explaining the worst-case time synchronization error (Part 1);

FIG. 15 is a diagram explaining the worst-case time synchronization error (Part 2);

FIG. 16 is a diagram showing the transmission queue setting;

FIG. 17 is a diagram showing the transfer setting;

FIG. 18 is a diagram explaining the residence time of the propagation delay measurement request message in the time synchronization bridge;

FIG. 19 is a diagram explaining the residence time of the first propagation delay measurement response message in the time synchronization bridge;

FIG. 20 is a diagram explaining the residence time of the first synchronization message in the time synchronization bridge;

FIG. 21A is a flowchart showing the initialization process performed by the time synchronization master;

FIG. 21B is a flowchart showing the initialization process performed by the time synchronization master;

FIG. 22 is a diagram explaining the designation of the transmission port;

FIG. 23 is a diagram explaining the identification of the reception port;

FIG. 24 is a flowchart showing the initialization process performed by the first time synchronization slave;

FIG. 25 is a flowchart showing the propagation delay time measurement process performed by the first time synchronization slave;

FIG. 26 is a flowchart showing the propagation delay time measurement process performed by the time synchronization master;

FIG. 27 is a flowchart showing the propagation delay time measurement process performed by the time synchronization master;

FIG. 28 is a flowchart showing the reference time distribution process performed by the time synchronization master; FIG. 29 is a flowchart showing the time difference calculation process of the clock of the time synchronization master performed by the first time synchronization slave;

FIG. 30 is a flowchart showing the current time estimation process of the clock of the time synchronization master performed by the first time synchronization slave;

FIG. 31 is a diagram showing the transmission queue setting of the second embodiment;

FIG. 32 is a diagram showing the transmission queue setting of the third embodiment;

FIG. 33 is a functional block diagram showing the overall configuration of the fourth embodiment; and

FIG. 34 is a functional block diagram showing the overall configuration of the fifth embodiment.

### DETAILED DESCRIPTION

In a data communication system for vehicles, which is mounted on a vehicle, various devices such as cameras and sensors are connected to electronic control units (hereinafter referred to as ECUs) located throughout the vehicle to implement advanced driver-assistance systems (ADAS) and autonomous driving. To chronologically grasp the data from these cameras and sensors, it is necessary to perform time synchronization among multiple ECUs connected via a communication network. Time synchronization protocols such as IEEE 1588 (Precision Time Protocol, PTP) or IEEE 802.1AS (Generalized Precision Time Protocol, gPTP) are being applied for in-vehicle use as methods for performing time synchronization.

In a configuration where a time synchronization master and a time synchronization slave perform time synchronization via Ethernet (registered trademark) as multiple time synchronization end stations, a time synchronization-compatible Ethernet switch that corresponds to the timestamp of the time synchronization standard is arranged as a time synchronization bridge between the time synchronization master and the time synchronization slave. The time synchronization-compatible Ethernet switch has the function of transmitting the residence time of the time synchronization message in the Ethernet switch to the time synchronization end station when relaying the time synchronization message sent and received between the time synchronization master and the time synchronization slave. The time synchronization end station uses the received residence time for time correction.

To implement the above function, the time synchronization bridge requires a computation core, software executed by the computation core, dedicated hardware, and the like, which poses a cost issue in the development and manufacturing of the software and hardware. To address such issues, for example, a related art discloses a configuration in which a time synchronization non-compatible Ethernet switch that does not correspond to the timestamp of the time synchronization standard is arranged as a time synchronization bridge between the time synchronization master and the time synchronization slave.

In the above-described configuration, it is possible to solve the problems caused by the arrangement of a time synchronization-compatible Ethernet switch. If messages other than time synchronization messages are stored in the transmission queue of the Ethernet switch, there is a risk of transmission delay of the time synchronization messages. In a configuration where a time synchronization non-compatible Ethernet switch is arranged, a new difficulty arises in that the greater the delay time, the lower the time synchronization accuracy, and the time synchronization master and the time synchronization slave cannot properly synchronize.

The present disclosure provides a technique to minimize the degradation of time synchronization accuracy while addressing the cost issues associated with the development and manufacturing of software and hardware.

According to one aspect of the present disclosure, in a time synchronization communication system a plurality of nodes transmit and receive time synchronization message via a communication network. The plurality of nodes include a first time synchronization end station, a second time synchronization end station, and a relay node that relays the time synchronization message transmitted and received between the first time synchronization end station and the second time synchronization end station. The relay node includes a plurality of ports that communicate with the first time synchronization end station and the second time synchronization end station. Each of the plurality of ports has a plurality of transmission queues capable of storing messages to be transmitted and set with a predetermined transmission priority control method. The plurality of transmission queues include one first transmission queue storing the time synchronization message and one or more second transmission queues storing messages other than the time synchronization message. The transmission priority of the first transmission queue is set higher than the transmission priority of the second transmission queue.

By dividing the multiple transmission queues into one first transmission queue that stores the time synchronization message and one or more second transmission queues that store messages other than the time synchronization message, and setting the transmission priority of the first transmission queue higher than that of the second transmission queue, it is possible to prioritize the transmission of time synchronization messages over messages other than time synchronization messages. This allows the relay node to be configured as a time synchronization non-compatible node while minimizing the residence time of time synchronization messages in the relay node. As a result, it is possible to minimize the degradation of time synchronization accuracy and ensure proper time synchronization between the time synchronization master and the time synchronization slave, while addressing the cost issues associated with the development and manufacturing of software and hardware.

Hereinafter, multiple embodiments will be described with reference to the drawings. In the subsequent embodiments, parts common to the preceding embodiments will be omitted from the description. In the drawings described, the time synchronization non-compatible Ethernet switch is shown as a gPTP non-compatible Ethernet switch, and the time synchronization message is shown as a gPTP message. Also, the storage of a message in the transmission queue is shown as enqueue, and the transmission of a message from the transmission queue is shown as dequeue.

### First Embodiment

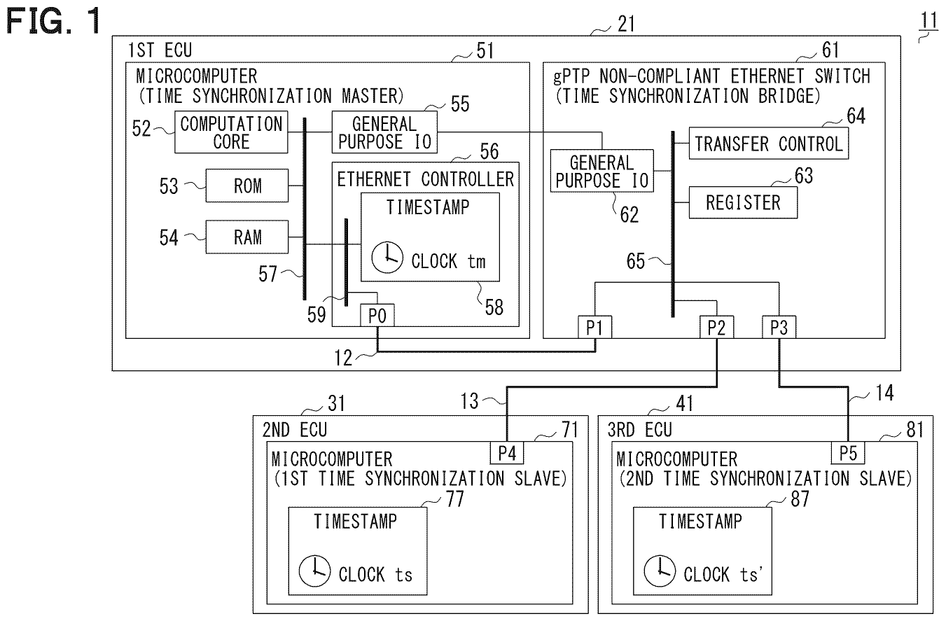

The first embodiment will be described with reference to FIG. 1 to FIG. 30. As shown in FIG. 1, the time synchronization communication system 11, as a data communication system for vehicles, includes a first ECU 21, a second ECU 31, and a third ECU 41. The time synchronization communication system 11 performs data communication using the time synchronization protocol IEEE 802.1AS (gPTP) among the first ECU 21, the second ECU 31, and the third ECU 41. In this embodiment, a configuration in which two time synchronization slaves are connected to the time synchronization master is illustrated, but the number of time synchronization slaves connected to the time synchronization master may be one or three or more.

The first ECU 21 includes a microcomputer 51 and a time synchronization non-compatible Ethernet switch 61. The microcomputer 51 is a node that distributes the reference time within the time synchronization communication system 11 and functions as the time synchronization master (corresponding to a first time synchronization end station, for example). The time synchronization non-compatible Ethernet switch 61 is a node that relays messages within the time synchronization communication system 11 and functions as a time synchronization bridge (corresponding to a relay node).

The microcomputer 51 is configured with a computation core 52, ROM 53, RAM 54, general-purpose IO 55, and an Ethernet controller 56 interconnected via a bus 57. The computation core 52 controls the overall operation of the first ECU 21 by performing arithmetic processing. The computation core 52 controls the transfer of messages by executing a message transfer control program. The ROM 53 is a storage area that stores various data. The RAM 54 is a storage area that functions as a work area when the computation core 52 performs arithmetic processing. The general-purpose IO 55 performs data communication conforming to a general-purpose communication protocol such as SPI (Serial Peripheral Interface) with the general-purpose IO of the time synchronization non-compatible Ethernet switch 61 described later.

The Ethernet controller 56 is configured with a timestamp unit 58 and a communication port PO interconnected via a bus 59. The timestamp unit 58 has a timer that measures the clock tm and records the time measured by the timer. The computation core 52 accesses the timestamp unit 58 via the buses 57 and 59 to read the time recorded by the timestamp unit 58 and stores the read time in the RAM 54. Alternatively, the time recorded by the timestamp unit 58 in the Ethernet controller 56 may be transferred and stored in the RAM 54 by an internal DMA (Direct Memory Access). The communication port P0 is connected to the communication port P1 of the time synchronization non-compatible Ethernet switch 61 via Ethernet 12. The communication port P0 performs data communication conforming to the Ethernet communication protocol with the communication port P1.

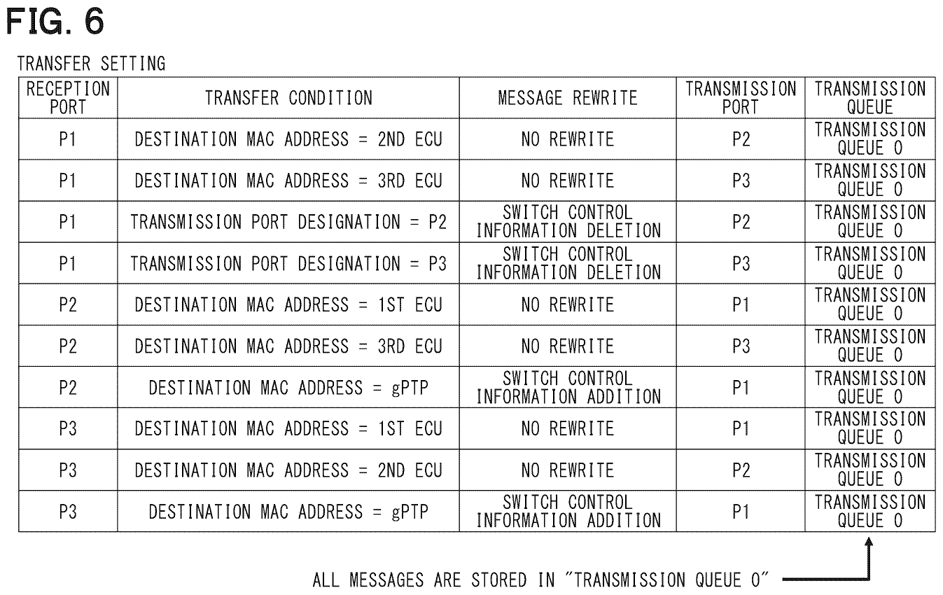

The time synchronization non-compatible Ethernet switch 61 is configured with a general-purpose IO 62, a register 63, a transfer control unit 64, and the communication ports P1, P2, and P3 interconnected via a bus 65. The general-purpose IO 62 performs data communication conforming to a general-purpose communication protocol with the general-purpose IO 55 of the microcomputer 51. The register 63 holds the transmission queue settings that define the transmission priority control method for each transmission queue and the transfer settings that define the control of message transfer, as shown in FIG. 5 and FIG. 6 described later. The transfer control unit 64 controls the transfer of messages between the communication port P1 and the communication port P2 and between the communication port P1 and the communication port P3 according to the transmission queue settings and transfer settings held in the register 63.

The communication port P1 performs data communication conforming to the Ethernet communication protocol with the communication port P0 of the microcomputer 51. The communication port P2 is connected to the communication port P4 of the second ECU 31 via Ethernet 13. The communication port P2 performs data communication conforming to the Ethernet communication protocol with the communication port P4. The communication port P3 is connected to the communication port P5 of the third ECU 41 via Ethernet 14. The communication port P3 performs data communication conforming to the Ethernet communication protocol with the communication port P5.

The time synchronization non-compatible Ethernet switch 61 does not have a computation core and operates under the control of the computation core 52 of the microcomputer 51. That is, the microcomputer 51, functioning as the time synchronization master, remotely controls the time synchronization non-compatible Ethernet switch 61, which functions as a time synchronization bridge. A time synchronization non-compatible may mean not recording the transmission and reception times when sending and receiving time synchronization messages. In other words, the Ethernet switch 61 described above does not record the transmission and reception times when sending and receiving time synchronization messages.

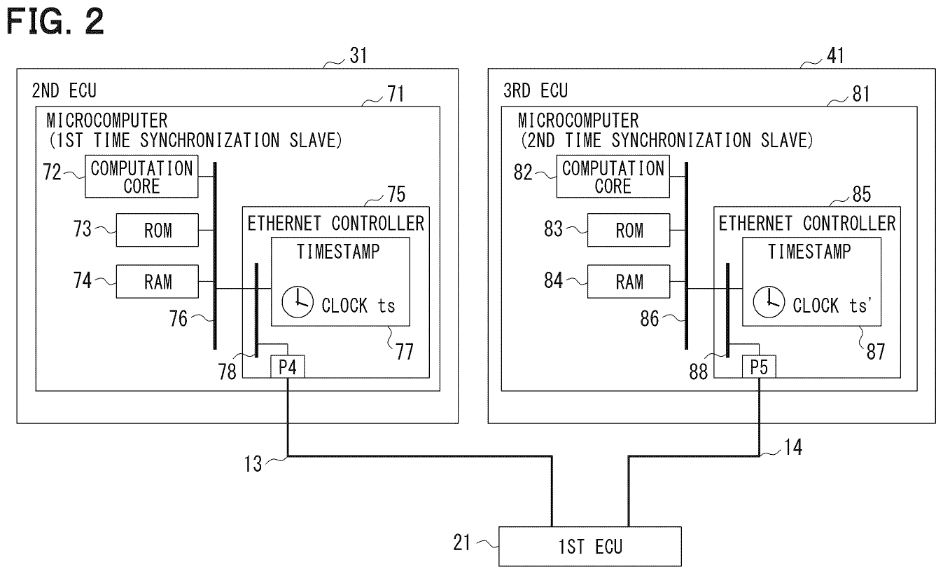

As shown in FIG. 2, the second ECU 31 includes a microcomputer 71. The microcomputer 71 is a node that synchronizes with the reference time distributed by the time synchronization master within the time synchronization communication system 11 and functions as the first time synchronization slave (corresponding to a second time synchronization end station, for example). The microcomputer 71 is configured with a computation core 72, the ROM 73, the RAM 74, and an Ethernet controller 75 interconnected via a bus 76. The computation core 72 controls the overall operation of the second ECU 31 by performing arithmetic processing. The ROM 73 is a storage area that stores various data. The RAM 74 is a storage area that functions as a work area when the computation core 72 performs arithmetic processing.

The Ethernet controller 75 is configured with a timestamp unit 77 and a communication port P4 interconnected via a bus 78. The timestamp unit 77 has a timer that measures the clock ts and records the time measured by the timer. The computation core 72 accesses the timestamp unit 77 via the buses 76 and 78 to read the time recorded by the timestamp unit 77 and stores the read time in the RAM 74. Alternatively, the time recorded by the timestamp unit 77 in the Ethernet controller 75 may be transferred to and stored in the RAM 74 by an internal DMA. The communication port P4 performs data communication conforming to the Ethernet communication protocol with the communication port P2 of the time synchronization non-compatible Ethernet switch 61.

The third ECU 41 has a similar configuration to the second ECU 31 and includes a microcomputer 81. The microcomputer 81 is a node that synchronizes with the reference time distributed by the time synchronization master within the time synchronization communication system 11 and functions as the second time synchronization slave (corresponding to a second time synchronization end station, for example). The microcomputer 81 is configured with a computation core 82, the ROM 83, the RAM 84, and an Ethernet controller 85 interconnected via a bus 86. The computation core 82 controls the overall operation of the third ECU 41 by performing arithmetic processing. The ROM 83 is a storage area that stores various data. The RAM 84 is a storage area that functions as a work area when the computation core 82 performs arithmetic processing.

The Ethernet controller 85 is configured with a timestamp unit 87 and a communication port P5 interconnected via a bus 88. The timestamp unit 87 has a timer that measures the clock ts′ and records the time measured by the timer. The computation core 82 accesses the timestamp unit 87 via the buses 86 and 88 to read the time recorded by the timestamp unit 87 and stores the read time in the RAM 84. Alternatively, the time recorded by the timestamp unit 87 in the Ethernet controller 85 may be transferred and stored in the RAM 84 by an internal DMA. The communication port P5 performs data communication conforming to the Ethernet communication protocol with the communication port P3 of the time synchronization non-compatible Ethernet switch 61.

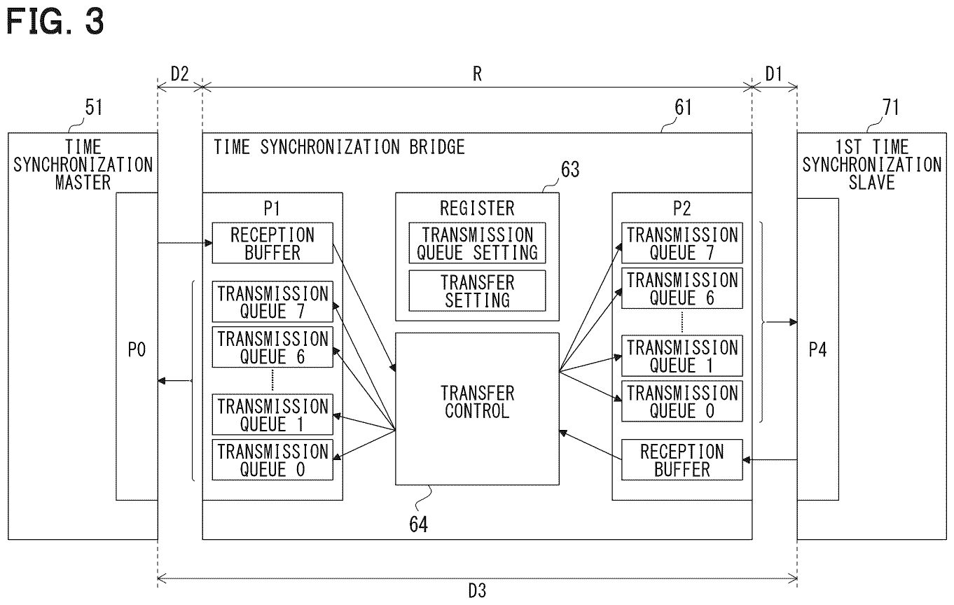

As shown in FIG. 3, in the time synchronization non-compatible Ethernet switch 61 functioning as a time synchronization bridge, the communication ports P1 to P3 each include one reception buffer and multiple transmission queues 0 to 7 (eight in this embodiment). Although the illustration of the communication port P3 is omitted in FIG. 3, it is similar to the communication port P2. Each transmission queue 0 to 7 can store multiple messages simultaneously. When a message transmitted from an external communication port is received by the reception buffer of the communication ports P1 to P3, the received message is output to the transfer control unit 64. The transfer control unit 64, upon receiving a message from the reception buffer of the communication ports P1 to P3, outputs the received message to one of the transmission queues 0 to 7. The transmission queues 0 to 7, upon receiving a message from the transfer control unit 64, transmit the received message to an external communication port.

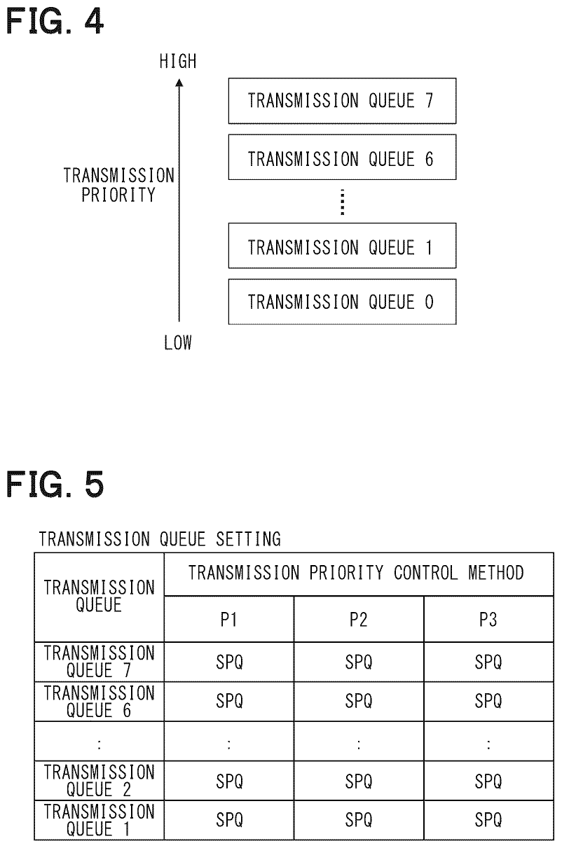

As shown in FIG. 4, the transmission queues 0 to 7 are set with transmission priorities in the order of transmission queue 7, the transmission queue 6, . . . , the transmission queue 1, and the transmission queue 0. The higher the numerical value from 0 to 7, the higher the transmission priority, and the lower the numerical value, the lower the transmission priority. That is, for example, if messages are simultaneously stored in the transmission queue 6 and the transmission queue 7, the transmission of all messages stored in the transmission queue 7 is completed and the transmission queue 7 is emptied before the transmission of messages stored in the transmission queue 6 begins.

Here, the transmission priority control method of the Ethernet switch will be described. The transmission priority control of the Ethernet switch means QoS (Quality of Service), which is control that determines from which transmission queue to transmit messages when multiple transmission queues exist in a communication port. In this embodiment, the following three methods are supported: SPQ (Strict Priority Queuing), WRR (Weighted Round Robin), and CBS (Credit Based Shaper). The methods are as follows.

SPQ: This method transmits messages from a lower-priority transmission queue only after the higher-priority transmission queue is emptied. Conversely, if messages continue to accumulate in the higher-priority transmission queue, there is a risk that messages from the lower-priority transmission queue will never be transmitted.

WRR: This method follows a weighted round-robin approach, where the bandwidth is determined by the weight set for each transmission queue. It does not have the same risk as SPQ.

CBS: This method follows the QoS control mechanism defined by IEEE 802.1Qav, where credits are consumed each time a message is taken out from the transmission queue, and messages are not taken out from the transmission queue until the credits are recovered after being fully consumed. It does not have the same risk as SPQ.

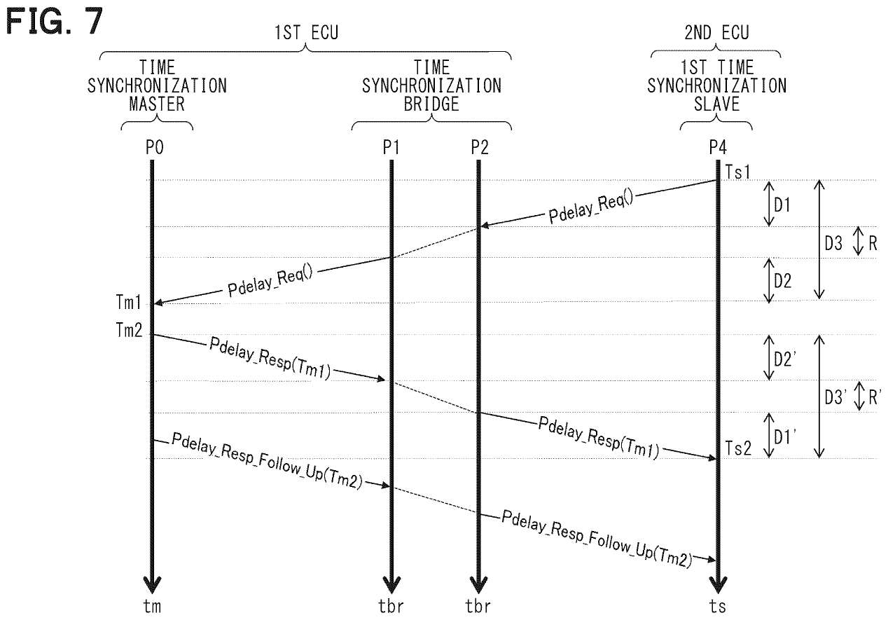

Generally, in the default setting, as shown in FIG. 5, SPQ is set for all transmission queues 0 to 7 by the transmission queue setting, and as shown in FIG. 6, the transmission queue 0 is set for all messages regardless of whether they are time synchronization messages by the transfer setting. Therefore, since all messages are stored in the transmission queue 0, if non-time synchronization messages accumulate in the transmission queue 0, the transmission of time synchronization messages is delayed, leading to a decrease in time synchronization accuracy. The decrease in time synchronization accuracy will be explained with reference to FIG. 7 to FIG. 9.

In the above configuration, the time required for a time synchronization message to pass through Ethernet 12 between the time synchronization master and the time synchronization bridge, the time required to pass through Ethernet 13 between the first time synchronization slave and the time synchronization bridge, and the time required to pass through Ethernet 14 between the second time synchronization slave and the time synchronization bridge occur as propagation delay times. Hereinafter, the measurement of propagation delay time and the distribution of the reference time will be described. In FIG. 7 and subsequent figures, the relationship between the time synchronization master and the first time synchronization slave is illustrated as an example, but the relationship between the time synchronization master and the second time synchronization slave is similar.

### (1) Measurement of Propagation Delay Time

The measurement of propagation delay time will be described with reference to FIG. 7 to FIG. 9. The time synchronization master, the time synchronization slave, and the time synchronization bridge transmit and receive a propagation delay measurement request message, a first propagation delay measurement response message, and a second propagation delay measurement response message as time synchronization messages for measuring propagation delay time. Each message is as follows.

Propagation Delay Measurement Request Message: This is a message sent by the time synchronization slave or the time synchronization bridge to the higher-level time synchronization bridge or time synchronization master to measure the propagation delay of the Ethernet to which it is connected. In FIG. 7 and subsequent figures, this is indicated as “Pdelay_Req (Propagation delay Request).”

First Propagation Delay Measurement Response Message: This is a message sent by the time synchronization master that received the propagation delay measurement request message, containing the reception timestamp (Tm1, described later) indicating the time when the propagation delay measurement request message was received by the time synchronization master. In FIG. 7 and subsequent figures, this is indicated as “Pdelay_Resp (Propagation delay Response).”

Second Propagation Delay Measurement Response Message: This is a message sent by the time synchronization master that sent the first propagation delay measurement response message, containing the transmission timestamp (Tm2, described later) indicating the time when the first propagation delay measurement response message was sent by the time synchronization master. In FIG. 7 and subsequent figures, this is indicated as “Pdelay_Resp_Follow_Up.”

As shown in FIG. 7, when the microcomputer 51 as the time synchronization master and the microcomputer 71 as the first time synchronization slave perform time synchronization, the timestamps are as follows.

Ts1: The transmission timestamp indicating the time when the propagation delay measurement request message was sent from the communication port P4.

Tm1: The reception timestamp indicating the time when the propagation delay measurement request message was received by the communication port P0.

Tm2: The transmission timestamp indicating the time when the first propagation delay measurement response message was sent from the communication port P0.

Ts2: The reception timestamp indicating the time when the first propagation delay measurement response message was received by the communication port P4.

The propagation delay times are as follows.

D1: The time from Ts1 to the time when the propagation delay measurement request message is received by the communication port P2, which is the propagation delay time between the first time synchronization slave and the time synchronization bridge.

D2: The time from when the propagation delay measurement request message is sent from the communication port P1 to Tm1, which is the propagation delay time between the time synchronization bridge and the time synchronization master.

D3: The time from Ts1 to Tm1, which is the propagation delay time of the propagation delay measurement request message from the first time synchronization slave to the time synchronization master. If the residence time of the propagation delay measurement request message in the time synchronization bridge is R, then D3=D1+R+D2 holds.

D2′: The time from Tm2 to the time when the first propagation delay measurement response message is received by the communication port P1, which is the propagation delay time between the time synchronization master and the time synchronization bridge.

D1′: The time from when the first propagation delay measurement response message is sent from the communication port P2 to Ts2, which is the propagation delay time between the time synchronization bridge and the first time synchronization slave.

D3′: The time from Tm2 to Ts2, which is the propagation delay time of the first propagation delay measurement response message from the time synchronization master to the first time synchronization slave. If the residence time of the first propagation delay measurement response message in the time synchronization bridge is R′, then the following relationship holds:

$$D {3}^{′} = D {2}^{′} + {R}^{′} + D {1}^{′} .$$

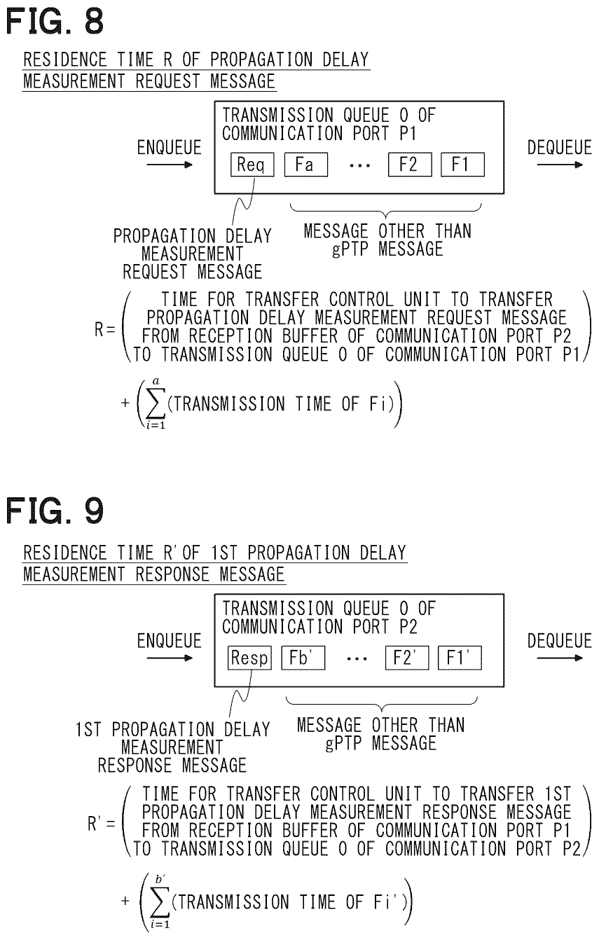

As shown in FIG. 8, when the propagation delay measurement request message is stored in the transmission queue 0 of the communication port P1, if messages other than the propagation delay measurement request message are already stored, these messages other than the propagation delay measurement request message are denoted as F1 to Fa. That is, if the number of messages residing in the transmission queue 0 of the communication port P1 at the time of transmission of the propagation delay measurement request message is a, then R is the sum of the time taken for the transfer control unit 64 to transfer the propagation delay measurement request message from the reception buffer of the communication port P2 to the transmission queue 0 of the communication port P1 and the total transmission time of F1 to Fa.

As shown in FIG. 9, when the first propagation delay measurement response message is stored in the transmission queue 0 of the communication port P2, if messages other than the first propagation delay measurement response message are already stored, these messages other than the first propagation delay measurement response message are denoted as F1′ to Fb′. That is, if the number of messages residing in the transmission queue 0 of the communication port P2 at the time of transmission of the first propagation delay measurement response message is b′, then R′ is the sum of the time taken for the transfer control unit 64 to transfer the first propagation delay measurement response message from the reception buffer of the communication port P1 to the transmission queue 0 of the communication port P2 and the total transmission time of F1′ to Fb′.

In this case, regarding the propagation delay time between the time synchronization master and the first time synchronization slave, if the communication between the communication port PO and the communication port P4 is logically treated as a single communication line without considering the existence of the time synchronization bridge, and the propagation delay time between the time synchronization master and the first time synchronization slave is denoted as D3mean, then the following relationship holds:

$$( Calculation formula 1 )$$

$$D 3 mean = ( D 3 + D {3}^{′} ) / 2 = \{ ( Ts 2 - Ts 1 ) - ( Tm 2 - Tm 1 ) \} / 2$$

The first time synchronization slave obtains Ts1 and Ts2 by itself, and Tm1 is stored in the first propagation delay measurement response message received from the time synchronization master via the time synchronization bridge, and Tm2 is stored in the second propagation delay measurement response message received from the time synchronization master via the time synchronization bridge. Therefore, by extracting and obtaining Tm1 from the first propagation delay measurement response message and Tm2 from the second propagation delay measurement response message, D3mean can be calculated using the calculation formula 1.

Here, IEEE 802.1AS-2011 assumes that D3 and D3′ are identical, so the calculation formula 1 holds, and D3mean can be calculated using the calculation formula 1. However, in reality, D1, D2, D2′, and D1′ do not fluctuate as long as the link method does not change. But as explained in FIG. 8 and FIG. 9, R and R′ fluctuate depending on the congestion status of the messages. That is, depending on the congestion status of the messages, R≠R′ may occur, and D3≠D3′ may occur. This decrease in time synchronization accuracy results in the issue that the time synchronization master and the time synchronization slave cannot properly synchronize.

### (2) Distribution of Reference Time

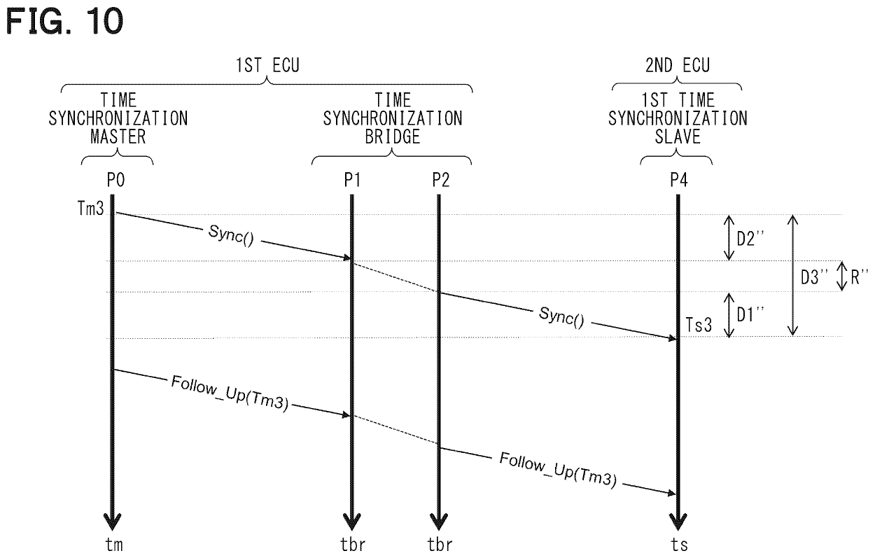

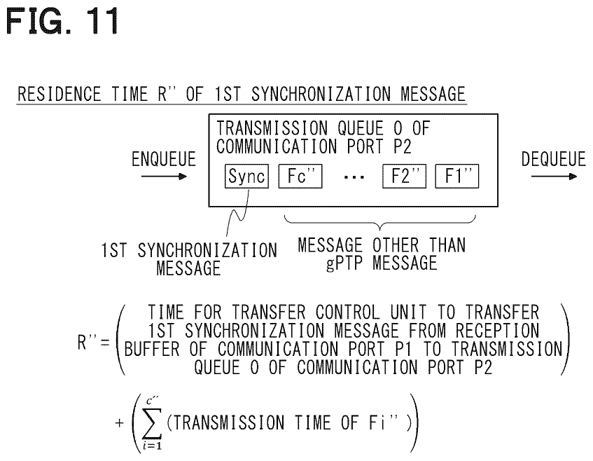

The distribution of the reference time will be described with reference to FIG. 10 and FIG. 11. The time synchronization master, the time synchronization slave, and the time synchronization bridge transmit and receive a first synchronization message and a second synchronization message as time synchronization messages for distributing the reference time. Each message is as follows:

First Synchronization Message: This is a message sent by the time synchronization master to the lower-level time synchronization bridge or the time synchronization slave to distribute the reference time of the time synchronization master. In FIG. 8 and subsequent figures, this is indicated as “Sync.”

Second Synchronization Message: This is a message sent by the time synchronization master to the lower-level time synchronization bridge or the time synchronization slave, containing the transmission time of the first synchronization message, the propagation delay time between the time synchronization master and the time synchronization bridge, and the residence time of the first synchronization message in the time synchronization bridge. In FIG. 8 and subsequent figures, this is indicated as “Follow_Up.”

As shown in FIG. 10, when the microcomputer 51 as the time synchronization master and the microcomputer 71 as the first time synchronization slave perform time synchronization, the timestamps are as follows.

Tm3: The transmission timestamp indicating the time when the first synchronization message was sent from the communication port P0.

Ts3: The reception timestamp indicating the time when the first synchronization message was received by the communication port P4. The propagation delay times are as follows.

D2″: The time from Tm3 to the time when the first synchronization message is received by the communication port P1, which is the propagation delay time between the time synchronization master and the time synchronization bridge.

D1″: The time from when the first synchronization message is sent from the communication port P2 to Ts3, which is the propagation delay time between the time synchronization bridge and the first time synchronization slave.

D3″: The time from Tm3 to Ts3, which is the propagation delay time of the first synchronization message from the time synchronization master to the first time synchronization slave. If the residence time of the first synchronization message in the time synchronization bridge is R″, then the following relationship holds:

$$D {3}^{″} = D {2}^{″} + {R}^{″} + D {1}^{″} .$$

As shown in FIG. 11, when the first synchronization message is stored in the transmission queue 0 of the communication port P2, if messages other than the first synchronization message are already stored, these messages other than the first synchronization message are denoted as F1″ to Fc″. That is, if the number of messages residing in the transmission queue 0 of the communication port P2 at the time of transmission of the first synchronization message is c″, then R″ is the sum of the time taken for the transfer control unit 64 to transfer the first synchronization message from the reception buffer of the communication port P1 to the transmission queue 0 of the communication port P2 and the total transmission time of F1″ to Fc″.

If the time difference between the clock tm of the time synchronization master and the clock ts of the first time synchronization slave is denoted as C, then the following relationship holds:

$$C = Ts 3 - ( Tm 3 + D {3}^{″} ) .$$

When expressing the clock tm of the time synchronization master in terms of the clock ts of the first time synchronization slave, the following relationship holds:

$$tm = ts - C = ts - Ts 3 + Tm 3 + D {3}^{″} .$$

Here, assuming D3″=D3mean,

$$C = Ts 3 - ( Tm 3 + D 3 mean ) \qquad ( Calculation formula 2 )$$

tm=ts−Ts3+Tm3+D3mean holds, and substituting the calculation formula 1,
tm=ts−Ts3+Tm3+{(Ts2−Ts1)−(Tm2−Tm1)}/2 holds, allowing the first time synchronization slave to estimate the clock tm of the time synchronization master.

The first time synchronization slave obtains Ts3 by itself. Since Tm3 is stored in the second synchronization message received from the time synchronization master via the time synchronization bridge, the first time synchronization slave extracts and obtains Tm3 from the second synchronization message, allowing it to estimate the clock tm of the time synchronization master using the calculation formula 2.

In this case as well, as explained in FIG. 11, R″ fluctuates depending on the congestion status of the messages. That is, the greater the deviation between D3mean and D3″, the greater the deviation between the estimated clock tm of the time synchronization master by the first time synchronization slave and the actual clock tm of the time synchronization master. This decrease in time synchronization accuracy results in the issue that the time synchronization master and the time synchronization slave cannot properly synchronize.

Here, the relationship between the residence time of the time synchronization message in the time synchronization bridge and the time synchronization error will be explained.

If the ideal value of the clock tm of the time synchronization master is tm (ideal value) and the estimated value of the clock tm of the time synchronization master is tm (estimated value), then

$$tm ( ideal value ) = ts - Ts 3 + Tm 3 + D {3}^{″}$$

$$tm ( estimated value ) = ts - Ts 3 + Tm 3 + D 3 mean$$

$$D {3}^{″} = D {1}^{″} + D {2}^{″} + {R}^{″}$$

$$D 3 mean = ( D 3 + D {3}^{′} ) / 2 = \{ ( D 1 + D 2 + R ) + ( D {1}^{′} + D {2}^{′} + {R}^{′} ) \} / 2.$$

If the link speed is constant,

$$D 1 = D {1}^{′} = D {1}^{″}$$

$$D 2 = D {2}^{′} = D {2}^{″} holds , so$$

$$D 3 mean = \{ 2 ( D {1}^{′} + D {2}^{′} ) + R + {R}^{′} \} / 2 = D {1}^{′} + D {2}^{′} + ( R + {R}^{′} ) / 2 holds .$$

If the time synchronization error is denoted as Terr,

$$Terr = tm ( ideal value ) - tm ( estimated value ) = ( ts - Ts 3 + Tm 3 + D {3}^{″} ) - ( ts - Ts 3 + Tm 3 + D 3 mean ) = D {3}^{″} - D 3 mean = ( D {1}^{″} + D {2}^{″} + {R}^{″} ) - \{ D {1}^{′} + D {2}^{′} + ( R + {R}^{′} ) / 2 \} = {R}^{″} - ( R + {R}^{′} ) / 2.$$

That is, the time synchronization error Terr is expressed as the difference between the residence time R″ of the first synchronization message at the time of transmission and the average of the residence time R of the propagation delay measurement request message at the time of transmission and the residence time R′ of the first propagation delay measurement response message at the time of transmission.

Hereinafter, a case where the time synchronization error is minimized, the worst-case scenario (Case 1), and the worst-case scenario (Case 2) will be described.

### (1) Case Where the Time Synchronization Error is Minimized

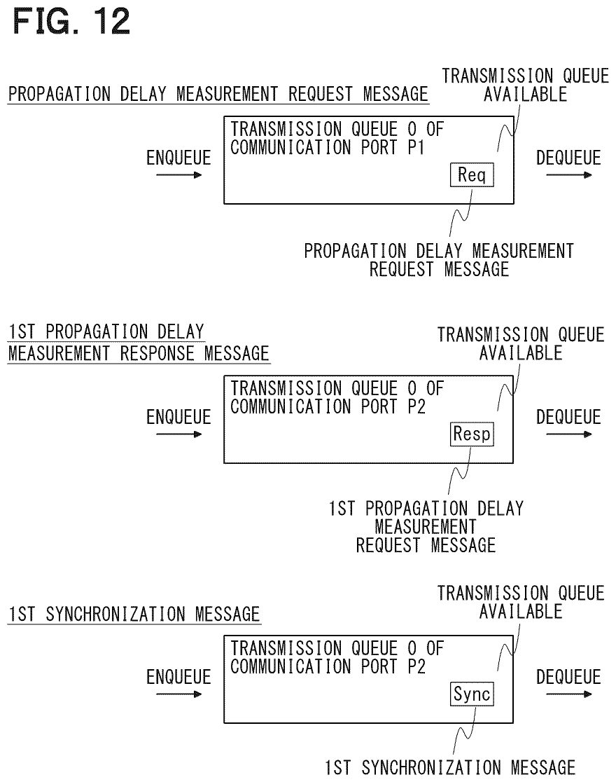

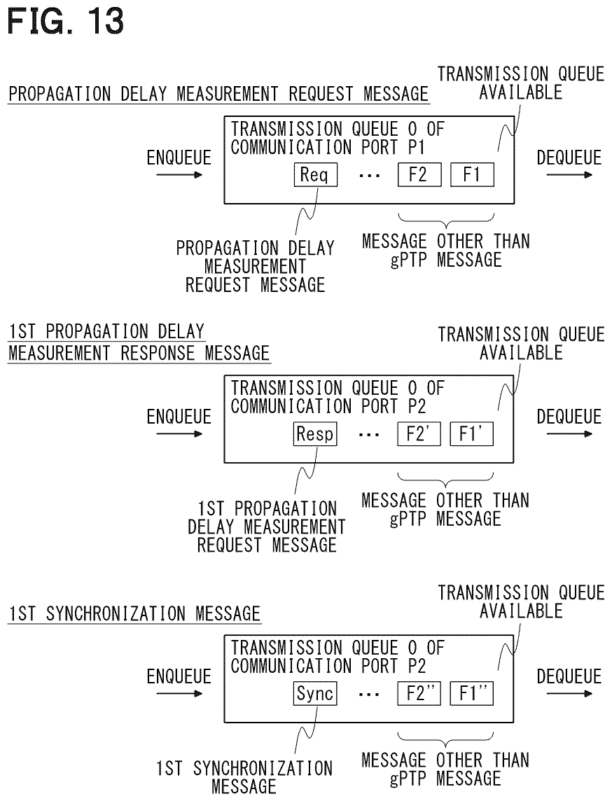

The condition for minimizing the time synchronization error is, as shown in FIG. 12, when there are no residing messages in each transmission queue 0 at the time of transmission of the propagation delay measurement request message, the first propagation delay measurement response message, and the first synchronization message. Alternatively, as shown in FIG. 13, it is when there are residing messages in each transmission queue, but the time for all residing messages in each transmission queue to complete transmission is the same.

In this case,

$$R = {R}^{′} = {R}^{″} holds , so$$

$$Terr = {R}^{″} - ( R + {R}^{′} ) / 2 = R - ( R + R ) / 2 = 0.$$

The time synchronization error becomes the ideal value of “0.”

### (2) Worst-Case Scenario for Time Synchronization Error (Case 1)

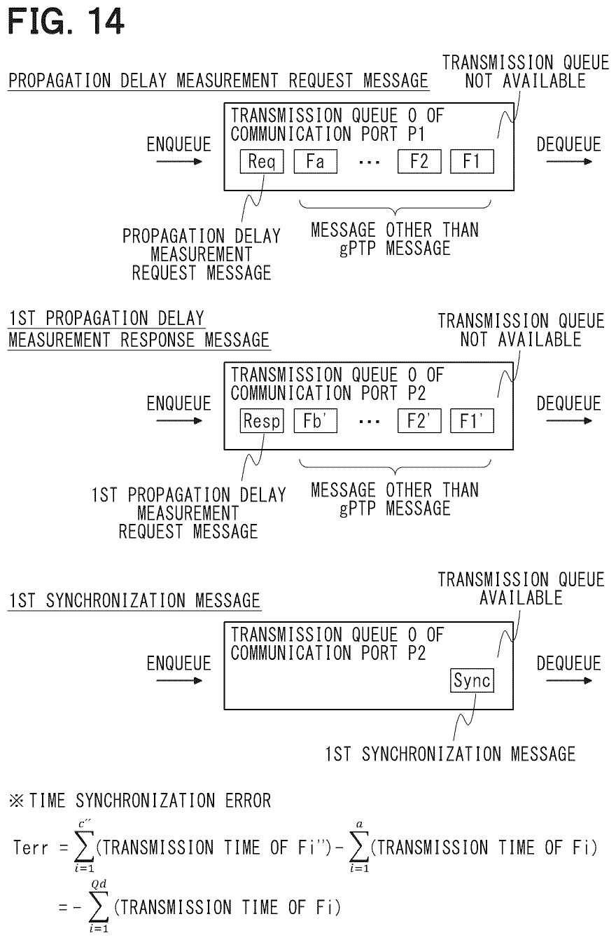

The condition for the worst-case scenario for time synchronization error (Case 1) is, as shown in FIG. 14, when the following three conditions are met.

Condition 1: R=R′, and if the maximum depth of each transmission queue 0 is Qd, then

$$a = {b}^{′} = Qd .$$

Condition 2: At the time of transmission of the propagation delay measurement request message and the first propagation delay measurement response message, each transmission queue 0 is fully occupied with residing messages, and all these residing messages are of the maximum frame size.

Condition 3: At the time of transmission of the first synchronization message, there are no residing messages in the transmission queue 0.

In this case,

$$R = {R}^{′} \neq {R}^{″} holds , so$$

$$Terr = {R}^{″} - ( R + {R}^{′} ) / 2 = {R}^{″} - ( R + R ) / 2 = {R}^{″} - R .$$

Here, as mentioned above, R″ is the sum of the time taken for the transfer control unit 64 to transfer the first synchronization message from the reception buffer of the communication port P1 to the transmission queue 0 of the communication port P2 and the total transmission time of F1″ to Fc″. R is the sum of the time taken for the transfer control unit 64 to transfer the propagation delay measurement request message from the reception buffer of the communication port P2 to the transmission queue 0 of the communication port P1 and the total transmission time of F1 to Fa. If the transfer time of the time synchronization message by the transfer control unit 64 is the same for both R and R″, then the time taken by the transfer control unit 64 to transfer the first synchronization message from the reception buffer of the communication port P1 to the transmission queue 0 of the communication port P2 and the time taken by the transfer control unit 64 to transfer the propagation delay measurement request message from the reception buffer of the communication port P2 to the transmission queue 0 of the communication port P1 cancel each other out, so Terr becomes the value obtained by subtracting the total transmission time of F1 to Fa from the total transmission time of F1″ to Fc″.

Here, given the above conditions, a=Qd, and c″=0, so the transmission time of F1″ to Fc″ becomes 0, and Terr becomes the total transmission time of F1 to FQd. Assuming the link speed is 100 (Mbps) and all the frames of the residing messages are of the maximum frame size of 1522 (bytes) in Ethernet,

$$Terr \approx - 123 * Qd ( μ s ) .$$

This means that if the absolute value of Terr exceeds the system requirement value, the system requirements cannot be guaranteed.

### (3) Worst-Case Scenario for Time Synchronization Error (Case 2)

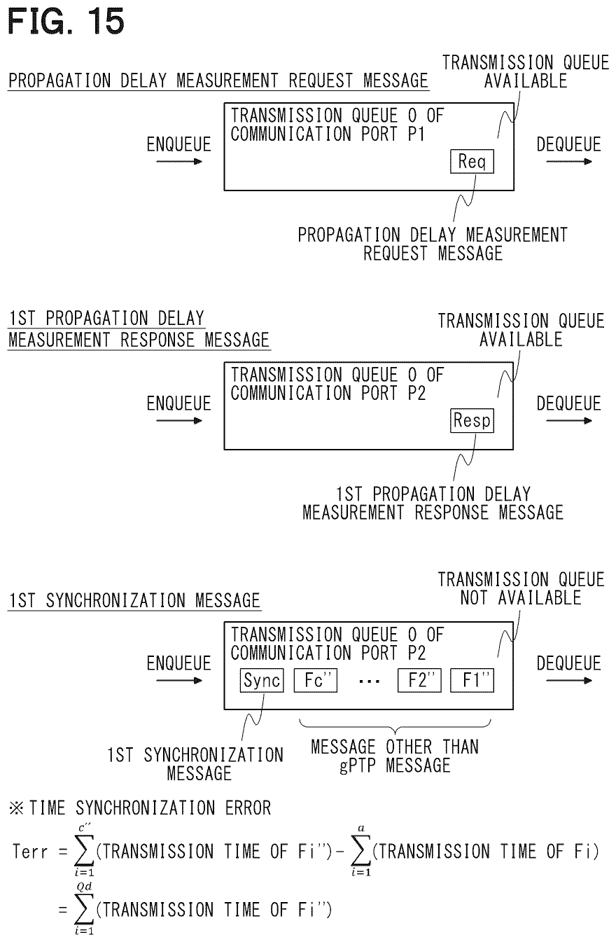

The condition for the worst-case scenario for time synchronization error (Case 2) is, as shown in FIG. 15, when the following three conditions are met.

Condition 1: R=R′, and if the maximum depth of each transmission queue 0 is Qd, then c″=Qd.

Condition 2: At the time of transmission of the propagation delay measurement request message and the first propagation delay measurement response message, there are no residing messages in each transmission queue 0.

Condition 3: At the time of transmission of the first synchronization message, each transmission queue 0 is fully occupied with residing messages, and all these residing messages are of the maximum frame size.

In this case as well, the time synchronization error is

$$Terr = {R}^{″} - ( R + {R}^{′} ) / 2 = {R}^{″} - ( R + R ) / 2 = {R}^{″} - R .$$

Similar to the “Worst-case scenario for time synchronization error (Case 1)” described above, Terr becomes the value obtained by subtracting the total transmission time of F1 to Fa from the total transmission time of F1″ to Fc″.

Here, given the above conditions, a=0, and c″=Qd, so the transmission time of F1 to Fa becomes 0, and Terr becomes the total transmission time of F1″ to FQd. Assuming the link speed is 100 (Mbps) and all the frames of the residing messages are of the maximum frame size of 1522 (bytes) in Ethernet,

$$Terr \approx - 123 * Qd ( μ s ) .$$

This also means that if the absolute value of Terr exceeds the system requirement value, the system requirements cannot be guaranteed.

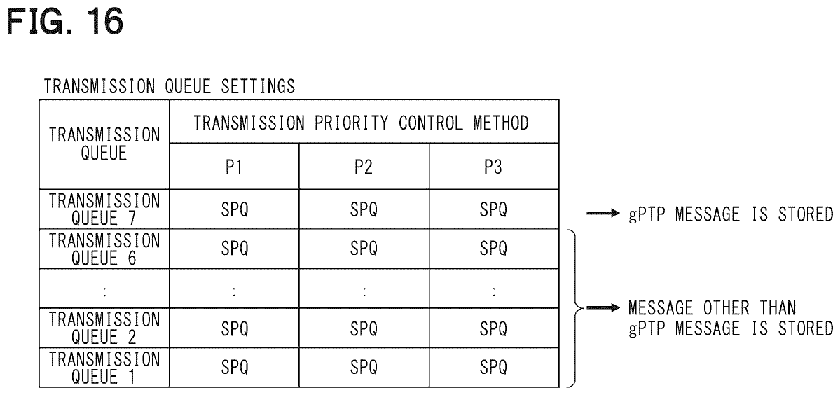

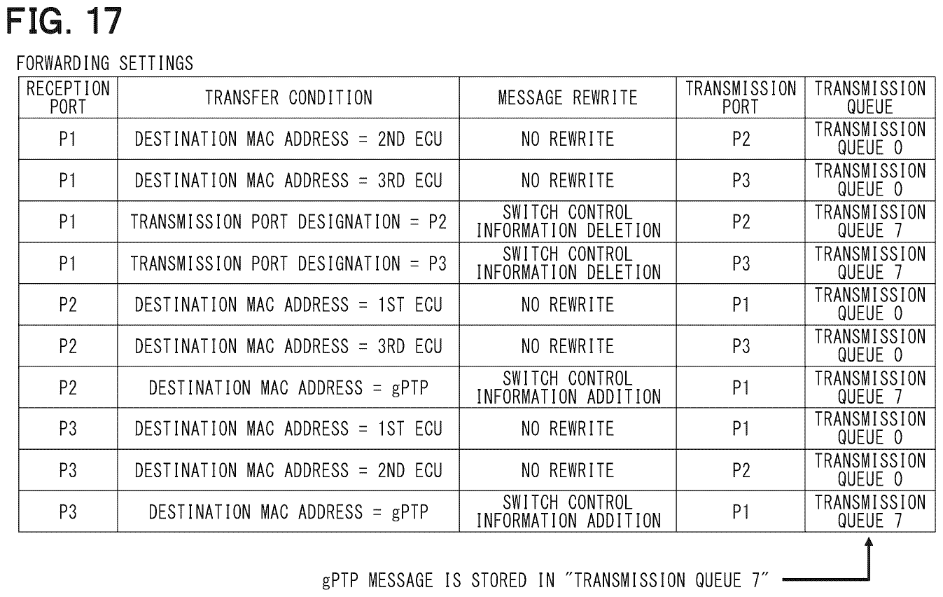

To address the issue of decreased time synchronization accuracy, this embodiment adopts the following configuration. As shown in FIG. 16, by setting the transmission queues, the transmission priority of the transmission queue 7 (corresponding to a first transmission queue) is set to the highest, and SPQ (Strict Priority Queuing) is set for all transmission queues 0 to 7. As shown in FIG. 17, by setting the transfer, the transmission queue 7 is set as the storage destination for time synchronization messages, and the transmission queues 0 to 6 (corresponding to a second transmission queue) are set as the storage destination for messages other than time synchronization messages.

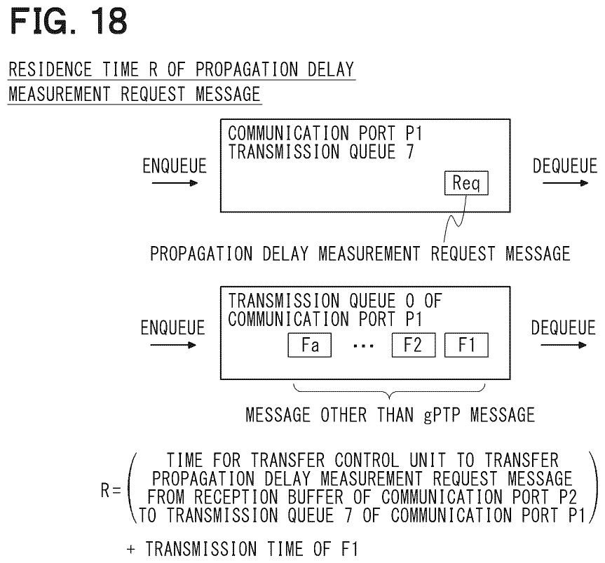

As shown in FIG. 18, when the propagation delay measurement request message is stored in the transmission queue 7 of the communication port P1, if messages other than the propagation delay measurement request message are already stored in the transmission queue 0 and the transmission of F1 has just started, the time synchronization bridge transmits the propagation delay measurement request message stored in the transmission queue 7 after the completion of the transmission of F1, regardless of the number of residing messages in the transmission queue 0. R is the sum of the time taken for the transfer control unit 64 to transfer the propagation delay measurement request message from the reception buffer of the communication port P2 to the transmission queue 7 of the communication port P1 and the total transmission time of F1.

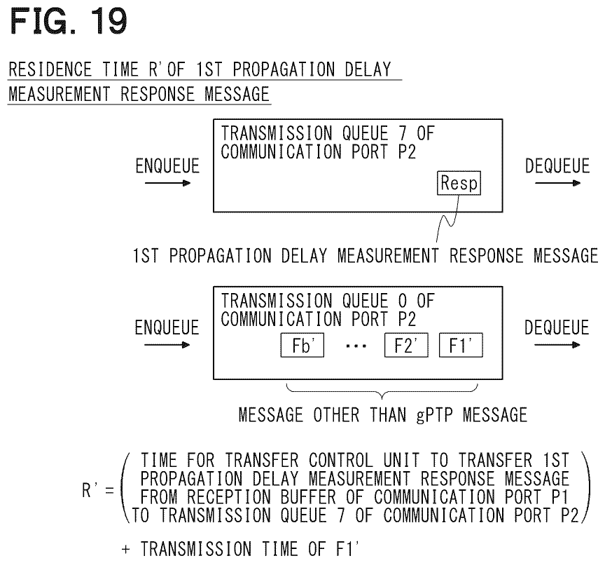

As shown in FIG. 19, when the first propagation delay measurement response message is stored in the transmission queue 7 of the communication port P2, if messages other than the first propagation delay measurement response message are already stored in the transmission queue 0 and the transmission of F1′ has just started, the time synchronization bridge transmits the first propagation delay measurement response message stored in the transmission queue 7 after the completion of the transmission of F1′, regardless of the number of residing messages in the transmission queue 0. R′ is the sum of the time taken for the transfer control unit 64 to transfer the first propagation delay measurement response message from the reception buffer of the communication port P1 to the transmission queue 7 of the communication port P2 and the total transmission time of F1′.

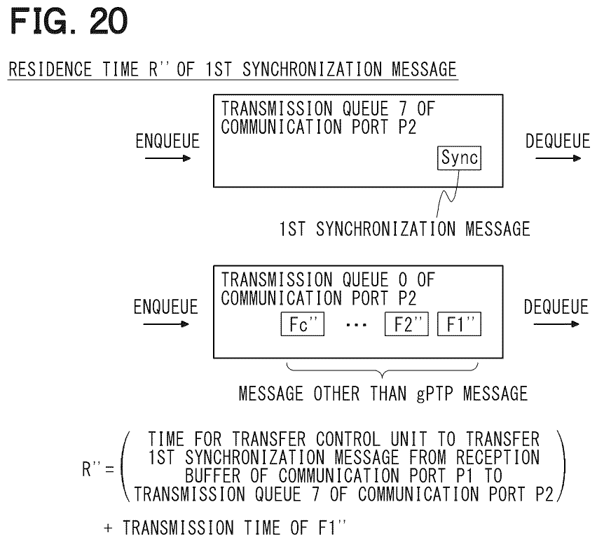

As shown in FIG. 20, when the first synchronization message is stored in the transmission queue 7 of the communication port P2, if messages other than the first synchronization message are already stored in the transmission queue 0 and the transmission of F1″ has just started, the time synchronization bridge transmits the first synchronization message stored in the transmission queue 7 after the completion of the transmission of F1″, regardless of the number of residing messages in the transmission queue 0. R″ is the sum of the time taken for the transfer control unit 64 to transfer the first synchronization message from the reception buffer of the communication port P1 to the transmission queue 7 of the communication port P2 and the total transmission time of F1″.

By configuring in this manner, the fluctuation range of the residence time of the time synchronization message can be suppressed to the transmission time of a single residing message, and the decrease in time synchronization accuracy can be avoided. Assuming the link speed is 100 (Mbps) and all the frames of the residing messages are of the maximum frame size of 1522 (bytes) in Ethernet, Terr≈±123 (μs), and compared to the worst-case scenarios for time synchronization error (1) and (2) described above, the absolute value of Terr can be suppressed, and the decrease in time synchronization accuracy can be avoided. As a result, the system requirements can be guaranteed.

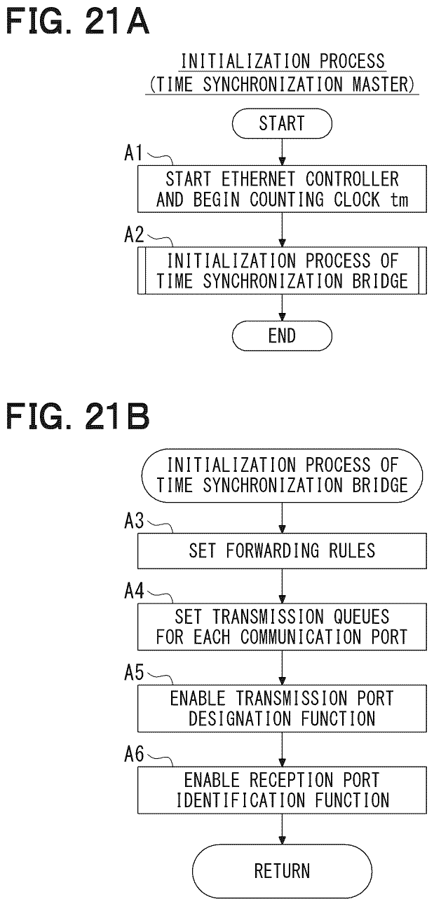

Next, the operation of the above-described configuration will be explained with reference to FIG. 21A to FIG. 30. Here, the initialization process performed by the time synchronization master, the initialization process performed by the first time synchronization slave, the propagation delay time measurement process performed by the first time synchronization slave, the propagation delay time measurement process performed by the time synchronization master, the reference time distribution process performed by the time synchronization master, the time difference calculation process of the time synchronization master's clock performed by the first time synchronization slave, and the current time estimation process of the time synchronization master's clock performed by the first time synchronization slave will be sequentially described. Note that in FIG. 21A, FIG. 21B, and subsequent drawings, the processes performed by the first time synchronization slave are illustrated as examples, but the processes performed by the second time synchronization slave are similar.

### (1) Initialization Process Performed by the Time Synchronization Master (Refer to FIG. 21A to FIG. 23)

In the time synchronization master, when the computation core 52 starts the initialization process, it activates the Ethernet controller 56 and starts counting the clock tm (A1). The computation core 52 outputs an initialization command from the general-purpose IO 55 to the time synchronization bridge and transitions to the initialization process of the time synchronization bridge (A2).

As described in FIG. 21B, when the computation core 52 starts the initialization process of the time synchronization bridge, it sets the transfer rules (A3). The computation core 52 sets the register 63 to transfer the time synchronization message received from the communication port P2 or the communication port P3 to the communication port P0.

The computation core 52 sets the transmission queues of each communication port (A4, corresponding to the setting procedure). The computation core 52 sets the transmission priority of the transmission queue 7 to the highest among the transmission queues 0 to 7 through the transmission queue setting and sets SPQ (Strict Priority Queuing) for all transmission queues 0 to 7. Through the transfer setting, the computation core 52 sets the transmission queue 7 as the storage destination for time synchronization messages and sets the transmission queues 0 to 6 as the storage destination for messages other than time synchronization messages. That is, the computation core 52 allocates multiple transmission queues 0 to 7 as one transmission queue 7 for storing time synchronization messages and the transmission queues 0 to 6 for storing messages other than time synchronization messages, and sets the transmission priority of the transmission queue 7 higher than the transmission priority of the transmission queues 0 to 6.

The computation core 52 sets the enablement of the transmission port designation function of the register 63 (A5). When transmitting a time synchronization message from the communication port P2 or the communication port P3, the computation core 52 adds transmission port information specifying the communication port to the Ethernet frame storing the time synchronization message. When the transmission port designation function of the register 63 is enabled, the time synchronization bridge identifies the transmission port information added to the time synchronization message received from the communication port P1, deletes the identified transmission port information, and transmits the Ethernet frame from the communication port indicated by the transmission port information.

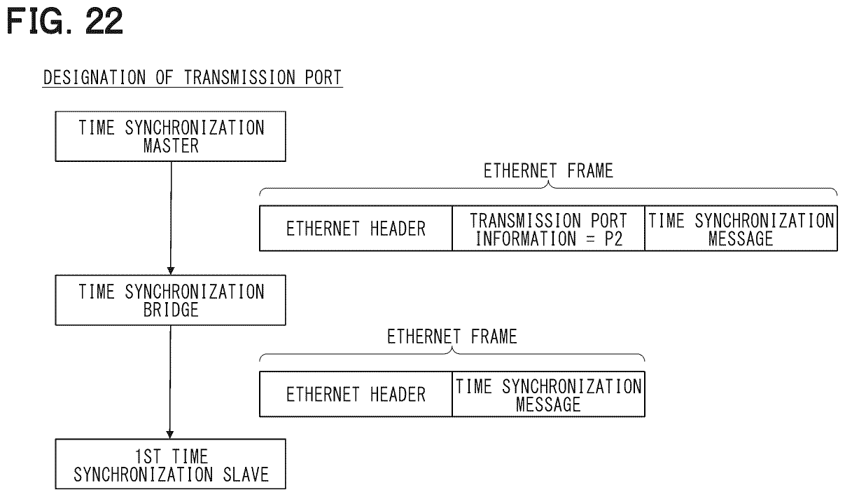

FIG. 22 shows the change in the Ethernet frame when transmitting a time synchronization message from the communication port P2. According to IEEE 802.1AS, the destination MAC address of the Ethernet frame storing the time synchronization message specifies a unique value “01-80-C2-00-00-0E” regardless of the transmission port. Since the transfer rule of the time synchronization bridge cannot identify the transmission destination communication port P2 or communication port P3 from the unique destination MAC address, the transmission port designation function is used as described above.

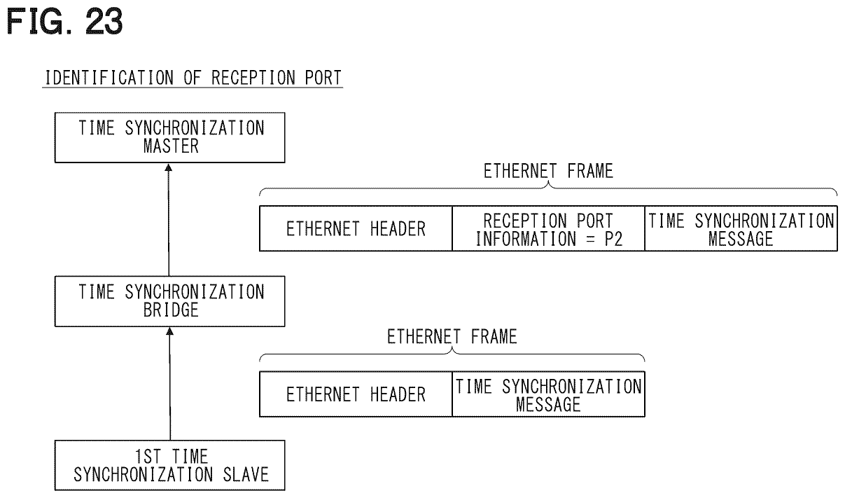

The computation core 52 sets the enablement of the reception port identification function of the register 63 (A6). When the reception port identification function is enabled, the time synchronization bridge adds reception port information indicating the communication port from which the time synchronization message was received to the Ethernet frame and transmits it from the communication port P1. The computation core 52 identifies the time synchronization slave that is the transmission source from the reception port information. FIG. 23 shows the change in the Ethernet frame when receiving a time synchronization message from the communication port P2. When the computation core 52 completes the initialization process of the time synchronization bridge, it returns to the initialization process and completes the initialization process.

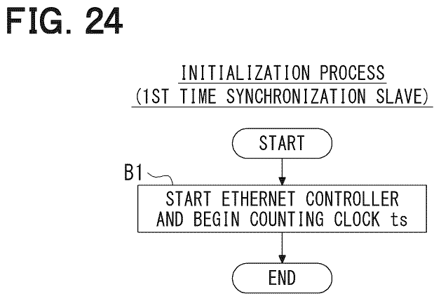

### (2) Initialization Process Performed by the First Time Synchronization Slave (Refer to FIG. 24)

In the first time synchronization slave, when the computation core 72 starts the initialization process, it activates the Ethernet controller 75, starts counting the clock ts (B1), and completes the initialization process.

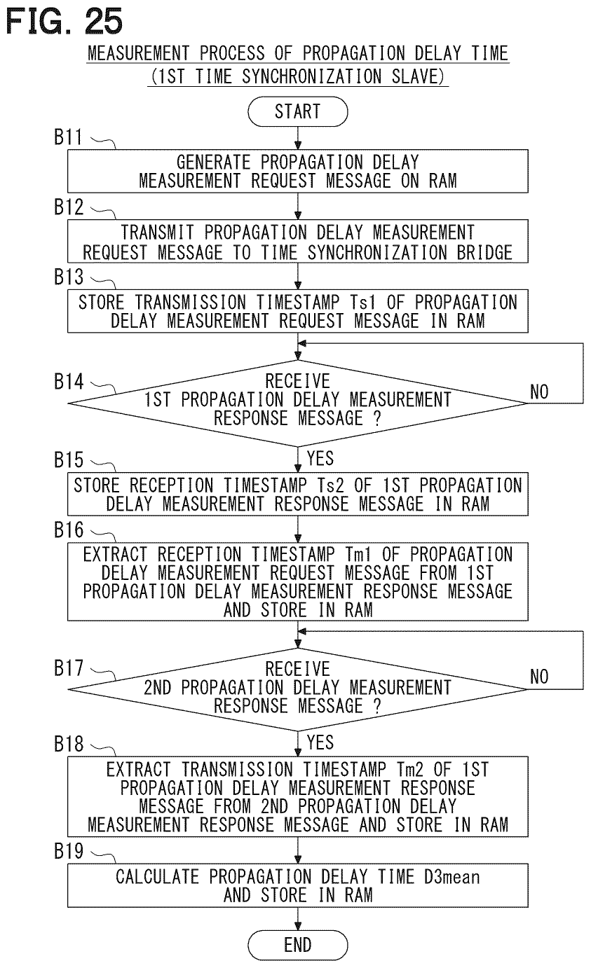

### (3) Propagation Delay Time Measurement Process Performed by the First Time Synchronization Slave (refer to FIG. 25)

In the first time synchronization slave, the computation core 72 performs the propagation delay time measurement process at predetermined intervals for sending the propagation delay measurement request message (e.g., every second). When the computation core 72 starts the propagation delay time measurement process, it generates the propagation delay measurement request message on the RAM 74 (B11). The computation core 72 sends the propagation delay measurement request message to the time synchronization bridge (B12). The computation core 72 stores the transmission timestamp Ts1 of the propagation delay measurement request message in the RAM 74 (B13). The computation core 72 waits to receive the first propagation delay measurement response message from the time synchronization bridge (B14).

When the computation core 72 determines that it has received the first propagation delay measurement response message from the time synchronization bridge (B14: YES), it stores the reception timestamp Ts2 of the first propagation delay measurement response message in the RAM 74 (B15). The computation core 72 extracts the reception timestamp Tm1 of the propagation delay measurement request message when it was received by the communication port P0 from the first propagation delay measurement response message and stores it in the RAM 74 (B16). The computation core 72 waits to receive the second propagation delay measurement response message from the time synchronization bridge (B17).

When the computation core 72 determines that it has received the second propagation delay measurement response message from the time synchronization bridge (B17: YES), it extracts the transmission timestamp Tm2 of the first propagation delay measurement response message when it was sent from the communication port P0 from the second propagation delay measurement response message and stores it in the RAM 74 (B18). The computation core 72 reads Ts1, Ts2, Tm1, and Tm2 stored in the RAM 74, calculates D3mean using the above-mentioned calculation formula 1, stores it in the RAM 74 (B19), and completes the propagation delay time measurement process.

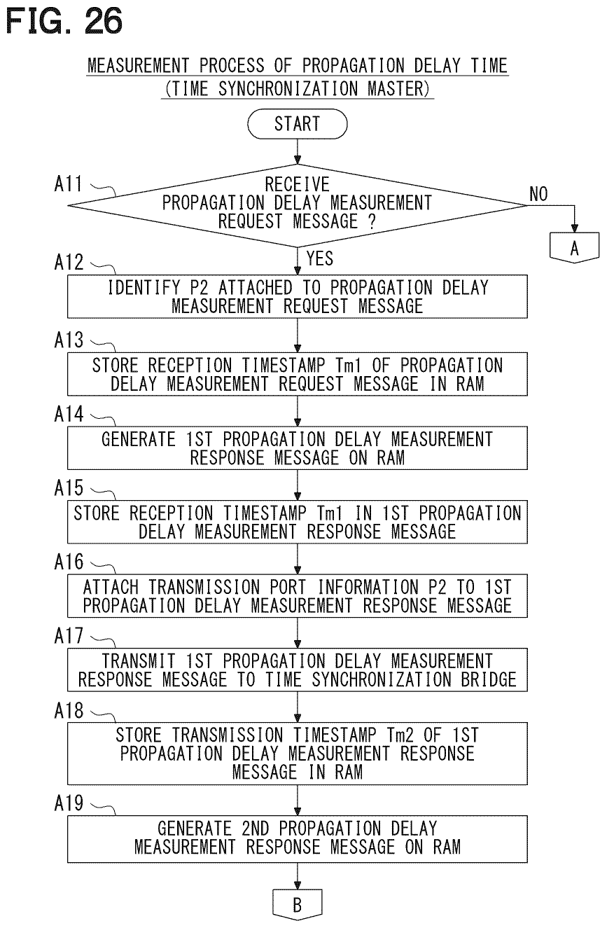

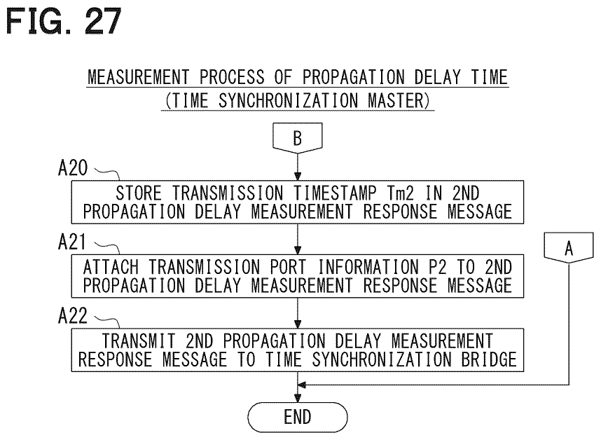

### (4) Propagation Delay Time Measurement Process Performed by the Time Synchronization Master (Refer to FIG. 26 to FIG. 27)

In the time synchronization master, the computation core 52 performs the propagation delay time measurement process at predetermined intervals for determining the reception of the propagation delay measurement request message (e.g., every millisecond) or by interrupt. When the computation core 52 starts the propagation delay time measurement process, it determines the reception of the propagation delay measurement request message from the time synchronization bridge (A11). If the computation core 52 determines that it has not received the propagation delay measurement request message from the time synchronization bridge (A11: NO), it completes the propagation delay time measurement process.

When the computation core 52 determines that it has received the propagation delay measurement request message from the time synchronization bridge (A11: YES), it identifies that the reception port information added to the propagation delay measurement request message is the communication port P2 (A12). The computation core 52 stores the reception timestamp Tm1 of the propagation delay measurement request message in the RAM 54 (A13).

The computation core 52 generates the first propagation delay measurement response message on the RAM 54 (A14). The computation core 52 stores the reception timestamp Tm1 of the propagation delay measurement request message in the first propagation delay measurement response message (A15). The computation core 52 adds the communication port P2 as the transmission port information to the first propagation delay measurement response message (A16). The computation core 52 sends the first propagation delay measurement response message to the time synchronization bridge (A17).

The computation core 52 stores the transmission timestamp Tm2 of the first propagation delay measurement response message in the RAM 54 (A18). The computation core 52 generates the second propagation delay measurement response message on the RAM 54 (A19). The computation core 52 stores the transmission timestamp Tm2 of the first propagation delay measurement response message in the second propagation delay measurement response message (A20). The computation core 52 adds the communication port P2 as the transmission port information to the second propagation delay measurement response message (A21). The computation core 52 sends the second propagation delay measurement response message to the time synchronization bridge (A22) and completes the propagation delay time measurement process.

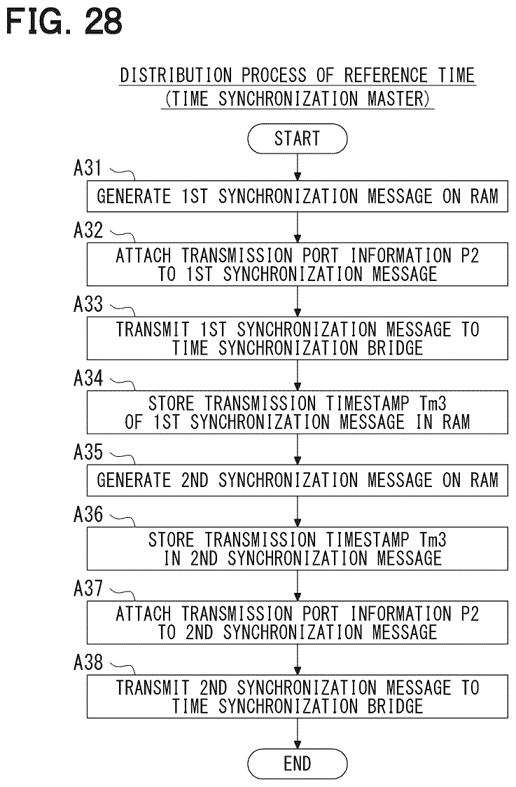

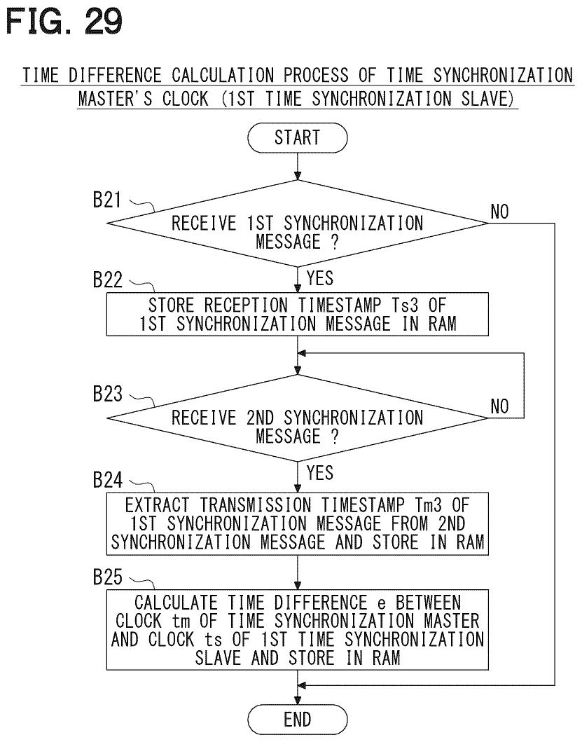

### (5) Reference Time Distribution Process Performed by the Time Synchronization Master (Refer to FIG. 28)

In the time synchronization master, the computation core 52 performs the reference time distribution process at predetermined intervals for sending the first synchronization message (e.g., every 125 milliseconds). When the computation core 52 starts the reference time distribution process, it generates the first synchronization message on the RAM 54 (A31). The computation core 52 adds the communication port P2 as the transmission port information to the first synchronization message (A32). The computation core 52 sends the first synchronization message to the time synchronization bridge (A33).

The computation core 52 stores the transmission timestamp Tm3 of the first synchronization message in the RAM 54 (A34). The computation core 52 generates the second synchronization message on the RAM 54 (A35). The computation core 52 stores the transmission timestamp Tm3 of the first synchronization message in the second synchronization message (A36). The computation core 52 adds the communication port P2 as the transmission port information to the second synchronization message (A37). The computation core 52 sends the second synchronization message to the time synchronization bridge (A38) and completes the reference time distribution process.

### (6) Time Difference Calculation Process of the Clock of the Time Synchronization Master Performed by the First Time Synchronization Slave (Refer to FIG. 29)

In the first time synchronization slave, the computation core 72 performs the time difference calculation process of the clock of the time synchronization master at predetermined intervals for determining the reception of the first synchronization message (e.g., every millisecond) or by interrupt. When the computation core 72 starts the time difference calculation process of the clock of the time synchronization master, it determines the reception of the first synchronization message from the time synchronization bridge (B21). If the computation core 72 determines that it has not received the first synchronization message from the time synchronization bridge (B21: NO), it completes the estimation process of the clock of the time synchronization master.

When the computation core 72 determines that it has received the first synchronization message from the time synchronization bridge (B21: YES), it stores the reception timestamp Ts3 of the first synchronization message in the RAM 74 (B22). The computation core 72 waits to receive the second synchronization message from the time synchronization bridge (B23).

When the computation core 72 determines that it has received the second synchronization message from the time synchronization bridge (B23: YES), it extracts the transmission timestamp Tm3 of the first synchronization message from the second synchronization message and stores it in the RAM 74 (B24).

The computation core 72 reads Ts3, Tm3, and D3mean stored in the RAM 74, calculates the time difference C between the clock tm of the time synchronization master and the clock ts of the first time synchronization slave using the above-mentioned calculation formula 2, stores it in the RAM 74 (B25), and completes the time difference calculation process of the clock of the time synchronization master.

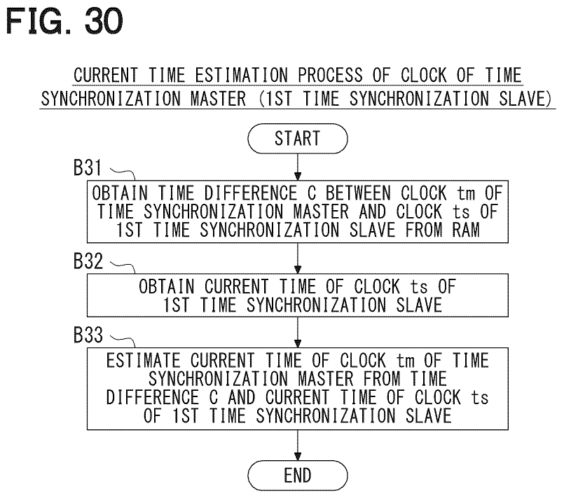

### (7) Current Time Estimation Process of the Clock of the Time Synchronization Master Performed by the First Time Synchronization Slave (Refer to FIG. 30)

In the first time synchronization slave, the computation core 72 performs the current time estimation process of the clock of the time synchronization master, for example, by acquiring sensor values from sensors connected to the first time synchronization slave. When the computation core 72 starts the current time estimation process of the clock of the time synchronization master, it obtains the time difference C between the clock tm of the time synchronization master and the clock ts of the first time synchronization slave from the RAM 74 (B31). The computation core 72 obtains the current time of the clock ts of the first time synchronization slave (B32). The computation core 72 subtracts the time difference C from the current time of the clock ts of the first time synchronization slave to estimate the current time of the clock tm of the time synchronization master (B33) and completes the current time estimation process of the clock of the time synchronization master.

As described above, according to the first embodiment, the following effects can be obtained. In the time synchronization bridge that relays the time synchronization messages transmitted and received between the time synchronization master and the time synchronization slave, multiple transmission queues 0 to 7 are divided into the transmission queue 7 for storing time synchronization messages and the transmission queues 0 to 6 for storing messages other than time synchronization messages, and the transmission priority of the transmission queue 7 is set higher than the transmission priority of the transmission queues 0 to 6. By prioritizing the transmission of time synchronization messages over messages other than time synchronization messages, it is possible to minimize the degradation of time synchronization accuracy while configuring the time synchronization bridge with an Ethernet switch 61 that does not support time synchronization. This allows the time synchronization master and the time synchronization slave to synchronize time appropriately while addressing the cost issues related to the development and manufacturing of software and hardware.

The transmission priority control method for the transmission queues 0 to 7 is set to the SPQ (Strict Priority Queuing) method. Time synchronization messages stored in the transmission queue 7 can be processed according to the SPQ method, and messages other than time synchronization messages stored in the transmission queues 0 to 6 can also be processed according to the SPQ method.

The above example illustrates a configuration where the Ethernet switch 61 that does not support time synchronization is arranged separately from the microcomputer 51 in the first ECU 21. However, the configuration may also be such that the Ethernet switch 61 that does not support time synchronization is built into the microcomputer 51. Additionally, the configuration may be such that the microcomputer 51 and the Ethernet switch 61 that does not support time synchronization are arranged in separate ECUs.

### Second Embodiment

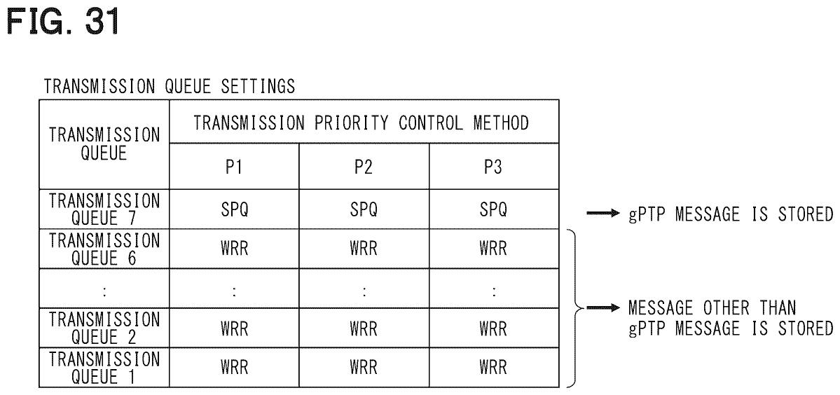

The second embodiment will be described with reference to FIG. 31. In the second embodiment, SPQ is set for the transmission queue 7, and WRR is set for the transmission queues 0 to 6 by transmission queue settings. According to the second embodiment, time synchronization messages stored in the transmission queue 7 can be processed according to the SPQ method, and messages other than time synchronization messages stored in the transmission queues 0 to 6 can be processed according to the WRR method.

### Third Embodiment

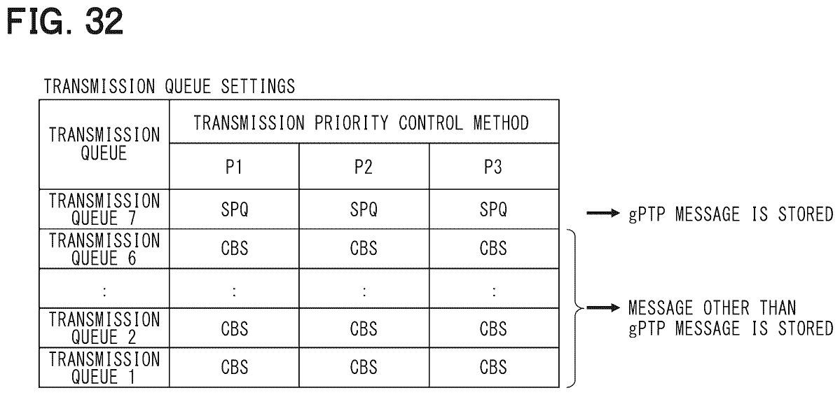

The third embodiment will be described with reference to FIG. 32. In the third embodiment, SPQ is set for the transmission queue 7, and CBS is set for the transmission queues 0 to 6. According to the third embodiment, time synchronization messages stored in the transmission queue 7 can be processed according to the SPQ method, and messages other than time synchronization messages stored in the transmission queues 0 to 6 can be processed according to the CBS method.

### Fourth Embodiment

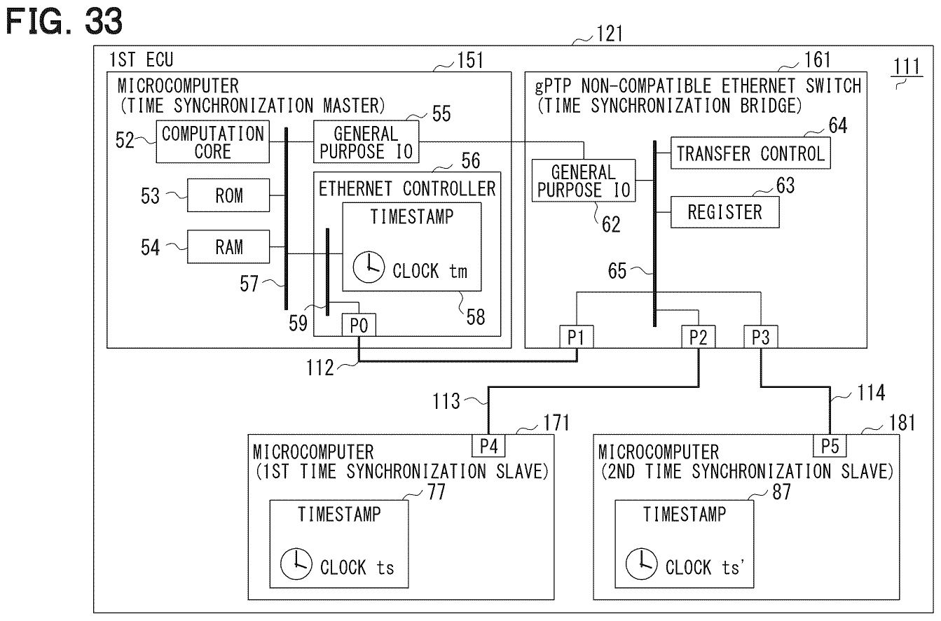

The fourth embodiment will be described with reference to FIG. 33. In the first embodiment described above, the time synchronization master, the first time synchronization slave, and the second time synchronization slave are arranged in separate ECUs 21, 31, and 41, respectively. In the fourth embodiment, the time synchronization master, the first time synchronization slave, and the second time synchronization slave are arranged in the same ECU.

The time synchronization communication system 111 includes a microcomputer 151, an Ethernet switch 161 that does not support time synchronization, and microcomputers 171 and 181 within the ECU 121. The microcomputer 151, the Ethernet switch 161 that does not support time synchronization, and the microcomputers 171 and 181 have the same configuration as the microcomputer 51, the Ethernet switch 61 that does not support time synchronization, and the microcomputers 71 and 81 described in the first embodiment, respectively, and function as the time synchronization master, the time synchronization bridge, and the first and second time synchronization slaves, respectively. The transmission queue settings and forwarding settings in the time synchronization bridge are the same as in the first embodiment.

The communication port P0 of the microcomputer 151 and the communication port P1 of the Ethernet switch 161 that does not support time synchronization are connected via the Ethernet 112. The communication port P2 of the Ethernet switch 161 that does not support time synchronization and the communication port P4 of the microcomputer 171 are connected via the Ethernet 113. The communication port P3 of the Ethernet switch 161 that does not support time synchronization and the communication port P5 of the microcomputer 181 are connected via Ethernet 114.

As described above, according to the fourth embodiment, in the time synchronization communication system 111, even when the time synchronization master, the time synchronization bridge, and the first and second time synchronization slaves are arranged in the same ECU 121, it is possible to minimize the degradation of time synchronization accuracy while configuring the time synchronization bridge with the Ethernet switch 161 that does not support time synchronization.

The above example illustrates a configuration in which both the first and second time synchronization slaves are arranged in the ECU 121 along with the time synchronization master and the time synchronization bridge. However, it is also possible to configure the system such that either the first or second time synchronization slave is arranged in the ECU 121 along with the time synchronization master and the time synchronization bridge. In other words, it is also possible to configure the system such that some of the multiple time synchronization slaves are arranged in separate ECUs.

### Fifth Embodiment

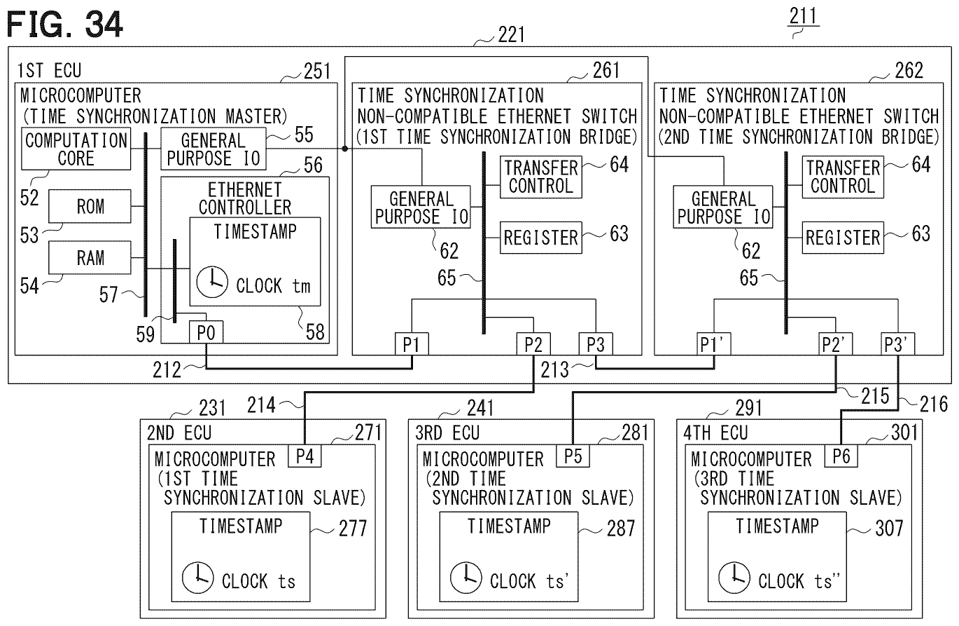

The fifth embodiment will be described with reference to FIG. 34. In the fifth embodiment, multiple time synchronization bridges are arranged in a cascade connection.

The time synchronization communication system 211 includes a first ECU 221, a second ECU 231, a third ECU 241, and a fourth ECU 291. The first ECU 221 includes a microcomputer 251 and Ethernet switches 261 and 262 that do not support time synchronization. The second ECU 231 includes a microcomputer 271. The third ECU 241 includes a microcomputer 281. The fourth ECU 291 includes a microcomputer 301. The microcomputer 271 includes a timestamp unit 277 that records time by measuring clock ts. The microcomputer 281 includes a timestamp unit 287 that records time by measuring clock ts'. The microcomputer 251, the Ethernet switches 261 and 262 that do not support time synchronization, and the microcomputers 271 and 281 have the same configuration as the microcomputer 51, the Ethernet switch 61 that does not support time synchronization, and the microcomputers 71 and 81 described in the first embodiment, respectively, and function as the time synchronization master, the first and second time synchronization bridges, and the first and second time synchronization slaves, respectively. The transmission queue settings and forwarding settings in the first and second time synchronization bridges are the same as in the first embodiment. The microcomputer 291 includes a timestamp unit 307 that records time by measuring clock ts″ and functions as the third time synchronization slave.

The communication port P0 of the microcomputer 251 and the communication port P1 of the Ethernet switch 261 that does not support time synchronization are connected via Ethernet 212. The communication port P3 of the Ethernet switch 261 that does not support time synchronization and the communication port P1′ of the Ethernet switch 262 that does not support time synchronization are connected via Ethernet 213 in a cascade connection. The communication port P2 of the Ethernet switch 261 that does not support time synchronization and the communication port P4 of the microcomputer 271 are connected via Ethernet 214. The communication port P2′ of the Ethernet switch 262 that does not support time synchronization and the communication port P5 of the microcomputer 281 are connected via Ethernet 215. The communication port P3′ of the Ethernet switch 262 that does not support time synchronization and the communication port P6 of the microcomputer 301 are connected via Ethernet 216.

As described above, according to the fifth embodiment, in the time synchronization communication system 211, even when multiple time synchronization bridges are arranged, it is possible to minimize the degradation of time synchronization accuracy while configuring the first and second time synchronization bridges with the Ethernet switch 161 that does not support time synchronization.

### Other Embodiments

The present disclosure has been described in accordance with the embodiments, but it is understood that the disclosure is not limited to these embodiments and structures. The present disclosure encompasses various modifications and variations within the scope of equivalency. Additionally, various combinations and forms, as well as other combinations and forms including only one element, more, or fewer elements, are also within the scope and spirit of the present disclosure.

Time synchronization messages and messages other than time synchronization messages may be stored together in the highest priority transmission queue 7.

Although the configuration in which the time synchronization master, the time synchronization slave, and the time synchronization bridge are connected via Ethernet has been illustrated, other communication networks may be adopted. For example, the time synchronization master, the time synchronization slave, and the time synchronization bridge may be connected via CAN (Controller Area Network) or FlexRay. Additionally, a configuration combining Ethernet, CAN, and FlexRay may also be adopted.

The time synchronization message may be a time synchronization message other than a propagation delay measurement request message, a propagation delay measurement response message, and a synchronization message. SPQ, WRR, and CBS may be mixedly set for the transmission queues 0to 6. The number of the transmission queues is not limited to eight; as long as time synchronization messages and messages other than time synchronization messages are stored separately, any number of the transmission queues of two or more may be used.

Although a data communication system for a vehicle mounted on a vehicle has been illustrated, and microcomputers and Ethernet switches built into ECUs have been illustrated as nodes, the present disclosure may also be applied to data communication systems other than for vehicle use.

The control unit and its methods described in the present disclosure may be realized by a dedicated computer provided by configuring a processor and memory programmed to execute one or more functions embodied by a computer program. Alternatively, the control unit and its methods described in the present disclosure may be realized by a dedicated computer provided by configuring a processor with one or more dedicated hardware logic circuits. Alternatively, the control unit and its methods described in the present disclosure may be realized by one or more dedicated computers provided by a combination of a processor and memory programmed to execute one or more functions and one or more hardware logic circuits. Additionally, the computer program may be stored as instructions executable by a computer on a computer-readable non-transitory tangible recording medium.

What is claimed is:

1. A time synchronization communication system comprising:
a plurality of nodes transmit and receive a time synchronization message via a communication network,
wherein
the plurality of nodes include:
a first time synchronization end station;
a second time synchronization end station; and
a relay node that relays the time synchronization message transmitted and received between the first time synchronization end station and the second time synchronization end station,
wherein
the relay node includes a plurality of ports that communicate with the first time synchronization end station and the second time synchronization end station,
each of the plurality of ports has a plurality of transmission queues capable of storing messages to be transmitted and set with a predetermined transmission priority control method,
the plurality of transmission queues include one first transmission queue storing the time synchronization message and one or more second transmission queues storing messages other than the time synchronization message,
a transmission priority of the first transmission queue is set higher than a transmission priority of the second transmission queue, and
the first time synchronization end station, the second time synchronization end station, and the relay node are arranged in a same electronic control unit.

2. The time synchronization communication system according to claim 1, wherein
the transmission priority control method of the first transmission queue is different from the transmission priority control method of the second transmission queue.

3. The time synchronization communication system according to claim 1, wherein
the transmission priority control method of the first transmission queue is set to Strict Priority Queuing (SPQ) method.

4. The time synchronization communication system according to claim 3, wherein
the transmission priority control method of the second transmission queue is set to Weighted Round Robin (WRR) method.

5. The time synchronization communication system according to claim 3, wherein
the transmission priority control method of the second transmission queue is set to Credit Based Shaper (CBS) method.

6. The time synchronization communication system according to claim 1, wherein
there are a plurality of second transmission queues.

7. The time synchronization communication system according to claim 6, wherein
the transmission priority control method of a portion of the second transmission queues is different from the transmission priority control method of a remaining part of the second transmission queues.

8. The time synchronization communication system according to claim 1, wherein
the relay node operates under a control of a first end station.

9. The time synchronization communication system according to claim 1, wherein
the relay node refrains from storing the transmission and reception time when transmitting and receiving the time synchronization message.

10. The time synchronization communication system according to claim 1, wherein
the time synchronization message includes:
a propagation delay measurement request message transmitted by the second time synchronization end station to measure a propagation delay time between the first time synchronization end station and the second time synchronization end station;
a first propagation delay measurement response message transmitted by the first time synchronization end station that includes a reception time of the propagation delay measurement request message at the first time synchronization end station;
a second propagation delay measurement response message transmitted by the first time synchronization end station that includes a transmission time of the first propagation delay measurement response message at the first time synchronization end station;
a first synchronization message transmitted by the first time synchronization end station to distribute a reference time of a time synchronization master to the second time synchronization end station; and
a second synchronization message transmitted by the first time synchronization end station that includes a transmission time of the first synchronization message at the first time synchronization end station.

11. A relay node in a time synchronization communication system in which a plurality of nodes transmit and receive a time synchronization message via a communication network, the relay node relaying the time synchronization message transmitted and received between a first time synchronization end station and a second time synchronization end station, the relay node comprising:
a plurality of ports that communicate with the first time synchronization end station and the second time synchronization end station,
wherein
each of the plurality of ports has a plurality of transmission queues capable of storing messages to be transmitted and set with a predetermined transmission priority control method,
the plurality of transmission queues include one first transmission queue storing the time synchronization message and one or more second transmission queues storing messages other than the time synchronization message,
a transmission priority of the first transmission queue is set higher than a transmission priority of the second transmission queue, and
the first time synchronization end station, the second time synchronization end station, and the relay node are arranged in a same electronic control unit.

12. A non-transitory computer readable storage medium storing a message transfer control program for a relay node in a time synchronization communication system in which a plurality of nodes transmit and receive a time synchronization message via a communication network, the relay node relaying the time synchronization message transmitted and received between a first time synchronization end station and a second time synchronization end station, and each of a plurality of ports that communicate with the first time synchronization end station and the second time synchronization end station having a plurality of transmission queues capable of storing messages to be transmitted, with a predetermined transmission priority control method set, the message transfer control program causing the relay node to:
assign the plurality of transmission queues as one first transmission queue storing the time synchronization message and one or more second transmission queues storing messages other than the time synchronization message, and
set a transmission priority of the first transmission queue higher than a transmission priority of the second transmission queue,
wherein
the first time synchronization end station, the second time synchronization end station, and the relay node are arranged in a same electronic control unit.
